(19) United States
(12) Patent Application Publication
(10) Pub. No.: US 2026/0152099 A1
(43) Pub. Date: Jun. 4, 2026

(54) VEHICULAR CHILD RESTRAINT

(71) Applicant: Dorel Australia Pty Ltd, Altona North (AU)

(72) Inventors: Alan TANNER, Altona North (AU); Tommy LIU, Altona North (AU); Tiffany KUO, Altona North (AU); Andy BEAUMONT, Altona North (AU); Andrew CRAWFORD, Altona North (AU); Leanne MACDONALD, Altona North (AU)

(21) Appl. No.: 19/398,696

(22) Filed: Nov. 24, 2025

(30) Foreign Application Priority Data
Nov. 29, 2024 (AU) 2024903952
Jul. 28, 2025 (AU) 2025903280

(51) Int. Cl. B60N 2/28

(52) U.S. Cl. CPC B60N 2/2869; B60N 2/2821

(57) ABSTRACT

A child restraint comprises a base, a mounting assembly rotatably attached to the base and a rotation locking mechanism. The base includes a lower portion configured to rest on a seat portion of a vehicle seat and an upper portion extending away from the lower portion and configured to rest on a back portion of the vehicle seat. The mounting assembly which is rotatably attached to the base, is configured to mount a seat for accommodating a child to the base in at least a forward-facing arrangement or a rearward facing arrangement. The rotation locking mechanism includes at least one motion blocking portion provided on one of the mounting assembly and an upper portion of the base. Two spaced locking portions are disposed on the other of the mounting assembly and the upper portion of the base.

### PRIORITY CLAIM

This application claims priority to Australian Patent Application No. AU 2024903952, filed Nov. 29, 2024, and Australian Patent Application No. AU 2025903280, filed Jul. 28, 2025, each of which is hereby incorporated in its entirety herein.

### BACKGROUND

The present disclosure relates to vehicular child restraints. For example, restraints which include a seat movably and/or removably mounted to a base.

### SUMMARY

A first aspect of the present disclosure provides a child restraint comprising:
a base including a lower portion configured to rest on a seat portion of a vehicle seat and an upper portion extending away from the lower portion configured to rest on a back portion of the vehicle seat;
a mounting assembly rotatably attached to the base and configured to mount a seat for accommodating a child to the base in at least a forward-facing arrangement or a rearward facing arrangement; and
a rotation locking mechanism, the rotation locking mechanism including:
at least one motion blocking portion provided on one of the mounting assembly and an upper portion of the base; and
   two spaced locking portions disposed on the other of the mounting assembly and the upper portion of the base, the two spaced locking portions configured such that the at least one motion blocking portion is disposed between the two spaced locking portions when the seat is secured in the forward-facing arrangement or the rearward facing arrangement thereby restricting rotation of the mounting assembly relative to the base,
   wherein the rotation locking mechanism is operable to selectively displace the locking portions thereby removing the restriction on rotation of the mounting assembly relative to the base.

The two spaced locking portions are disposed on the upper portion of the base and the at least one motion blocking portion is provided on the mounting assembly.

The rotation of the mounting assembly is restricted or restrained by the capturing of the motion blocking portion between the locking portions. A small amount of movement or play of the motion blocking portion between the locking portions might be permissible however. When the locking portions are displaced by operation of an actuator, the mounting assembly may rotate about a seat rotation axis that projects upwardly from a central part of the bottom portion of the base.

The mounting assembly may be configured to mount the seat to the base in at least a forward-facing arrangement and a rearward facing arrangement. The at least one motion blocking portion may be associated with the forward facing arrangement of the seat or the rearward facing arrangement of the seat. The mounting assembly may have a first motion blocking portion associated with the forward facing arrangement of the seat. The mounting assembly may have a second motion blocking portion associated with the rearward facing arrangement of the seat. The motion blocking portion or portions may each include a projection which protrudes away from the mounting assembly, preferably generally toward the base, when the mounting assembly is mounted to the base. The projection or projections may include a plate, such as a curved plate. The plate may project substantially orthogonally to an exterior surface of the mounting assembly. The plate may include a flat portion and a curved portion. The curved portion may form a hook shape on the free end of the flat portion of the plate. The plate may have a generally J-shaped profile.

Alternatively, or in addition, the motion blocking portion or portions may be disposed in a recess which extends into the mounting assembly. The recess may be a slot, a groove, a channel, a pocket.

The mounting assembly may be configured to releasably mount the seat to the base such that the seat is selectively removable. The mounting assembly may include a seat locking arrangement as described below in relation to the second aspect.

The base may define an inner space in which the mounting assembly and the seat may be disposed. The base may define a concave portion. The concave portion may be disposed on the lower portion of the base. The mounting assembly may be at least partially disposed in the concave portion. The mounting assembly may be of complementary shape to the concave portion of the base.

As described above, the seat rotation axis may extend generally upwardly away from the lower portion. In some embodiments, the seat rotation axis may be substantially orthogonal to the lower portion, preferably substantially orthogonal to a plane which lies on a rim of the concave portion.

The locking mechanism may include an actuator. Preferably, the actuator is operable to selectively displace the locking portions thereby removing the restriction on rotation of the mounting assembly relative to the base. The actuator may be provided on the base. The actuator may be disposed away from the two spaced locking portions. The actuator may be disposed on the lower portion of the base. The actuator may be disposed on the lower portion of the base in a location remote from where the upper portion extends from the lower portion. The actuator may be disposed on the lower portion of the base in a location opposite from where the upper portion extends from the lower portion.

The actuator may be operably connected to the locking portions. Selective movement of the actuator may displace the locking portions. The actuator may be operably connected to the locking portions using a connecting element. The connecting element may include a linkage. The connecting element may include a linkage including a rod, a bar, a cable, or a combination thereof. The actuator may include a slide, a lever, a button, or a handle. In a preferred embodiment, the actuator includes a slide connected to a cable which extends to the locking portions such that the locking portions are selectively displaceable on movement of the slide.

The base may include a support assembly. The support assembly may be configured to provide structural support to the base. The support assembly may extend from the lower portion of the base to the upper portion of the base. The support assembly may be disposed toward the midline of the child restraint when viewed from the forward facing or rearward facing direction. The support assembly may include a beam. The beam may be configured to be accommodated within the lower portion and the upper portion of the base. The beam may include a first portion disposed in the lower portion and a second portion disposed in the upper portion. The first portion of the beam may be disposed in a generally or substantially horizontal position when the restraint is in use. The second portion of the beam may be disposed in a generally upward or substantially upright position when the restraint is in use. The beam may include a third portion intermediate the first and second portions. The third portion may be curved from the generally or substantially horizontal position to the generally upward or substantially upright position.

The support assembly may include a first beam and a second beam. The first and second beams may be arranged as described in the previous paragraph. The first and second beams may be disposed next to one another. The first and second beams may be substantially parallel. The first and second beams may be disposed on either side of the midline of the restraint.

The locking portions are provided on a single locking element. The locking element may be mounted to the support assembly. The locking element may be mounted to the second portion of the support assembly. The locking element may be pivotably mounted to the support assembly. The locking element may be biased by a biasing element. The locking element may be biased by a biasing element into a first position. The locking element may be selective displaceable to a second position on operation of the actuator. When in the first position, the locking portions of the locking element may protrude into the inner space of the base. When in the second position, the locking portions of the locking element may be displaced away from the inner space of the base. The locking portions may be located inside the base, preferably the upper portion of the base, when in the second position.

The locking element may include first and second spaced apart locking arms. The locking portions may be provided on the locking arms. The locking portions may be provided on respective distal ends of the locking arms. The locking arms may be joined by an intermediate portion. The intermediate portion may extend between the first and second locking arms. The intermediate portion may connect to a proximal end of the first and second arms which is opposite to the locking portions. The locking element may have a generally U-shaped profile or generally C-shape profile.

A pivot may be provided on the locking arms. A biasing element may connect to the locking arms or the intermediate portion. The connecting element associated with the actuator may connect to the locking element, preferably at one or both the locking arms or the intermediate portion. The biasing element and the connecting element may connect to the same positions on the locking element. The biasing element and the connecting element may connect to different positions on the locking element.

The locking arms may be generally planar. Each locking arm may include a body portion and a nose portion. The nose portion may extend away from the body portion. The locking portions may be provided on the nose portions. The body portion may include the pivot. The biasing element and/or the connecting element may connect to one or both bodies of the locking arms.

Each of the locking portions may include a ramp portion. The ramp portions may be configured to allow the motion blocking portion to move the locking portions from the first position to the second position. The ramp portions may be configured to allow the motion blocking portion to move the locking portions from the first position to the second position when the motion blocking portion is rotating into either the forward or rearward facing position. The ramp portion may be provided on the locking arms. The ramp portion on one locking portion may protrude generally away from the other locking portion. The ramp portions may be on the outside of the locking arms.

Preferably, the ramp portions may each be a separate ramp component mounted to the locking portions, preferably the locking arms. The ramp portions may include a ramp surface. The ramp portions may include a ramp body. The ramp surface may be at an angle to a first side of the ramp body (e.g. the first ramp body side). The first ramp body side may be substantially parallel to the locking arm. The ramp body may include a second ramp body side which, when mounted to the locking portion, is substantially parallel to the locking arms. The first and second ramp body sides may be substantially parallel to each other. The ramp portion may be mounted to the locking portion such that the second ramp body side is substantially flush with the locking arm. The first ramp body side may face away from the locking arm. The second ramp body side may be larger in a length dimension than the first ramp body side. The ramp surface may extend between the first and second ramp body side such that the ramp surface is not orthogonal to the first and second ramp body side. The ramp surface may extend between a first end of the first ramp body side and a first end of the second ramp body side. The ramp surface may be at an angle to the locking arm. The angle of the ramp surface to the locking arm may be in the range of about 10 degrees to about 80 degrees, preferably about 30 degrees to about 60 degrees, or more preferably about 45 degrees.

Each of the ramp portions may be mounted to the locking portions using a mechanical fastener such as a bolt, a screw or a rivet. Preferably, each the ramp portions may be mounted to the respective locking portions using a screw fastener. A threaded hole may be provided on the ramp portion and configured to receive the screw fastener. The threaded hole may be provided on the ramp body. The threaded hole may be provided on the second ramp body side. The ramp portion may include a pin. The pin may be configured to engage with a locating hole in the locking portion, preferably on the locking arm. The pin may be provided on the second ramp body side. The engagement between the pin and the locating hole may locate the ramp portion on the locking portion. The engagement between the pin and the locating hole may resist movement or rotation of the ramp portion with respect to the locking portion.

In an alternative embodiment, the ramp portions may each be integrally formed with respective locking portions. In this embodiment, the locking arms may not be generally planar. The locking portions may include a contour portion. The ramp portions may be at least partially defined by a contour portion. The contour portions may be formed by angling or bending a portion of the locking portions or the locking arms to form the contours. Alternatively, the ramp portions may be formed by a thicker portion of the locking portion. The ramp portion may project from the respective locking portion in a direction generally away from the other locking portion. The ramp portion may include a ramp surface. The ramp surface may be at an angle to the locking arm. The angle of the ramp surface to the locking arm may be in the range of about 10 degrees to about 80 degrees, preferably about 30 degrees to about 60 degrees, or more preferably about 45 degrees.

The intermediate portion may be generally planar. The intermediate portion may be at least as long as the motion blocking portion of the mounting assembly. Accordingly, the distance or space between the locking arms may be at least as wide as the motion blocking portion of the mounting assembly.

The locking element may be connected to the beam or beams. The locking element may be connected to the beam or beams via at least one pivot shaft which mounts to the pivot of the locking element. The at least one pivot shaft may be mounted to the beam or beams using a bracket. The locking element may be arranged on the beam or beams such that the locking arms extend either side of the beam or beams. The intermediate portion may extend across the beam or beams. The intermediate portion may extend across the beam or beams on a side which his toward an exterior of the base.

In an alternative embodiment, the locking portions may be provided on separate locking elements, preferably a first locking element and a second locking element. Each locking element may include a locking arm. The locking elements may be substantially the same as described above but are not connected by the intermediate portion. The distance or space between the first and second locking elements may be at least as wide as the motion blocking portion of the mounting assembly.

The locking elements may be connected to the beam or beams. The locking elements may be connected to the beam or beams via at least one pivot shaft which mounts to the pivots of the locking elements. The at least one pivot shaft may be mounted to the beam or beams using a bracket. The locking element may be arranged on the beam or beams such that the locking arms extend either side of the beam or beams.

In either embodiment, the bracket which mounts the locking element to the beam or beams may include a first bracket arm and a second bracket arm. The bracket arms may be spaced from one another. The bracket arms may be spaced from one another by a web portion. The web portion may extend between the first and second bracket arms. The bracket arms may extend away from the inner space of the base. The web portion may extend across the beam or beams. The web portion may extend across the beam or beams on a side which is toward the inner space of the base. The bracket arms may be spaced apart by an amount which allows the bracket arms to be disposed between the locking arms. The bracket arms may include the at least one pivot shaft. The bracket arms may each include a pivot shaft configured to interact with the pivot on the locking arms. A single pivot shaft may extend between the first and second bracket arms. The bracket may be arranged on the beam or beams such that the pivot shaft extends across the beam or beams on a side which his toward the inner space of the base. The bracket may include a reinforcing element. The reinforcing element may extend between the bracket arms. The reinforcing element may extend between the bracket arms across the beam or beams. The reinforcing element may extend between the bracket arms across the beam or beams on a side which side which is toward an exterior of the base.

The mounting assembly may be rotatably connected to the base via a bearing assembly. The mounting assembly may be rotatably connected to the base at the support assembly. The mounting assembly may be connected to the beam or beams. The mounting assembly may be connected to the first portion of the support assembly. The mounting assembly may be connected to the first portion of the support assembly via a coupling. The bearing assembly may be mounted to the coupling.

The restraint may further include a second rotation locking mechanism arranged on the base. The second rotation locking mechanism may include a second actuation mechanism disposed on the base. Alternatively, the second actuation mechanism may be operable using the first actuator. The second rotation locking mechanism may include two space locking portions which are similar to those described above.

In a preferred embodiment, the second rotation locking mechanism differs from the first rotation locking mechanism. The second rotation locking mechanism may include locking portions that are combined with a fulcrum. The locking portions may be provided on one end of the fulcrum. The locking portions may be biased toward a locked position by a biasing element. The fulcrum may be pivotally mounted to the base at an end opposite the locking portions. The fulcrum may be a third-class lever. The locking portions may be moved out of the locked position by at least one motion blocking portion imparting a lateral force on one of the locking portions. The second rotation locking mechanism may provide a resistance to rotation that is less than a resistance to rotation provided by the first rotation locking mechanism.

The child restraint may further include a seat configured to accommodate a child or an infant. The seat may be selectively removable from the child restraint. The child restraint may further include a seat latching arrangement and associated features as described below in relation to the second aspect. Any of the features described below in relation to the second aspect of the present disclosure may have application to the first aspect of the present disclosure.

A second aspect of the present disclosure provides a child restraint comprising:
a base configured to rest on a vehicle seat;
a seat including a bottom portion and a backrest portion defining an interior for accommodating a child, the seat further including a first attachment portion disposed on an exterior of the backrest portion and a second attachment portion disposed on an exterior of the bottom portion;
a mounting assembly disposed on the base including a first mount and a second mount;
wherein the first attachment portion and the first mount are configured to lockingly engage, and the second attachment portion and the second mount are configured to lockingly engage; and
wherein the seat is removable by selectively disengaging the first attachment portion and the second attachment portion from their respective first and second mounts.

The first attachment portion and the first mount may form a first latch. The second attachment portion and the second mount may form a second latch. Each latch may include a bar and a catch.

The exterior surface of the seat may include a recess. The recess may extend from the bottom portion to the backrest portion. The recess may take the form of a groove or channel. The recess may be configured such that the mounting assembly is receivable within the recess when the seat is mounted to the mounting assembly. The first attachment portion may be disposed within the recess. The second attachment portion may be disposed within the recess.

The mounting assembly may be configured to be of complementary shape to the recess in the seat. The mounting assembly may be a curved or arc shape. The mounting assembly may have a generally U-shape or C-shape. The mounting element may be generally elongate in shape.

The mounting assembly may have a first end and a second end. The first mount may be disposed toward the first end. The second mount may be disposed toward the second end. Preferably, the mounts are provided on an upward facing side of the mounting assembly so that they may engage the attachment portions.

In an embodiment, one of the first attachment portion and the first mount includes a first bar and the other of the first attachment portion and the first mount includes a first catch to receive the first bar. The locking engagement may operate to restrict the first bar from dislocating from the first catch. Preferably, the first attachment portion is the first bar and the first mount is the first catch.

The first bar may be disposed within the recess at the backrest portion of the seat. The first bar may extend substantially across the recess. The first catch may include a groove for receiving the first bar. The first catch preferably further includes a latch element to retain the first bar in the groove.

The latch element may be positionable to a latched position in which the bar is retained in the groove and an unlatched position in which the bar is removable from the groove. The latch element is disengaged when in the unlatched position. The latch element may include a latch plate. The latch plate may include a main portion and a finger portion which projects away from the main portion. The finger portion may have a wedge shape. The finger portion may have a lower edge that is colinear with a lower edge of the main portion. An upper edge of the finger portion may be at an acute angle to the lower edge.

The latch element may be biased toward the latched position, preferably by a latch biasing element. In the latched position the bar may be retained in the groove by the lower edge of the finger portion. When the bar is inserted into the groove, the angled upper edge provides a means for the bar to displace the latch plate and fall into the groove. Once the bar clears the finger portion and is fully seated in the groove, the latch plate is returned to the latched position by the patch biasing element.

The latch plate may include a slot. The slot may be formed in the main portion. The slot may include an inclined portion. The slot may have a generally vertical portion disposed toward the finger portion and an angled portion the extends upwardly and away from the finger portion. An operator element may engage with the slot. When in the latched position, the operator element is located toward the top of the slot. When in the unlatched position, the operator element is displaced toward the bottom of the slot. The operator element may be operably connected to an unlocking mechanism, described further below. The operator element may be operable by the unlocking mechanism to move within the slot and cause movement of the latch plate from the latched to the unlatched positions.

The latch element may include first and second latch plates, the latch plates may be as described above in the immediately preceding paragraphs. The latch plates may be spaced apart from one another. The latch plates may be connected by the operator element only. The first and second latch plates are then separate plates which are joined by the operator element to form the latch element. In a preferred embodiment, the latch plates are additionally joined by a cross plate. The cross plate may be located on an edge of the latch plates that is opposite the finger portions.

In an embodiment, one of the second attachment portion and the second mount includes a second bar and the other of the second attachment portion and the second mount includes a second catch to receive the second bar. The locking engagement my operate to restrict the second bar dislocating from the second catch. Preferably, the second attachment portion is a bar and the second mount is a catch.

The second attachment portion may include a third bar. The second catch may include first and second catch portions. The first and second catch portions may be arranged to catch the second and third bars of the second attachment portion. The first and second catch portions of the second latch may each be a plate. The second catch portion may include a recess configured to receive the second and third bar. The second catch portion may include a first recess configured to receive the second bar. The second catch portion may include a second recess configured to receive the third bar. The first and second catch portions may be selectively movable on operation of an unlocking mechanism, discussed further below. The first and second catch portions may be selectively movable from a latched position in which the second and third bars are retained in the recess (or first and second respective recesses) by the first and second latch portions, to an unlatched position in which the second and third bars are removable from the recess or recesses.

The first and second latches may be selectively moveable to an unlocked position so that the attachment portions may be removable from the respective first and second mounts. The latches may be independently selectively moveable. The latches may be simultaneously selectively moveable. The mounting assembly may include an unlocking mechanism for selectively moving the first and second latches to the unlocked position simultaneously. The mounting assembly may include unlocking mechanisms associated with the first and second latches for selectively moving the first and second latches to the unlocked position independently of one another.

The unlocking mechanism may be located toward one end of the mounting assembly. The unlocking mechanism may be located toward the second end of the mounting assembly. The unlocking mechanism may be located near to the second mount, for example near to the second latch.

The unlocking mechanism may include an unlocking plate. The unlocking plate may be coupled to the second latch. The unlocking plate may be coupled to the first latch. The unlocking plate may be coupled to the first latch via a connecting member. The connecting member may include a linkage. The linkage may include a rod, a bar, or a cable. The unlocking plate may be configured to be movable with respect to the mounting assembly to thereby operate the unlocking mechanism. The unlocking plate may be slidable or rotatable relative to the mounting assembly. The unlocking plate may include a lever, a handle, or a button to facilitate movement. In a preferred embodiment, the unlocking mechanism is slidable relative to the mounting assembly. When moved, the unlocking plate engages with the second latch to unlatch the second latch. The unlocking plate also simultaneously causes actuation of the first latch via a cable that extends from the unlocking plate to the operator element.

The mounting assembly may be rotatably attached to the base. The mounting assembly and/or the base may be arranged as described above in relation to the first aspect.

Any of the features described above in relation to the first aspect of the present disclosure may have application to the second aspect of the present disclosure.

It will also be understood that the present disclosure(s) disclosed and defined in this specification extends to all alternative combinations of two or more of the individual features mentioned or evident from the text or drawings. All of these different combinations constitute various alternative aspects of the present disclosure.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a perspective and diagrammatic view of a first embodiment of a child restraint, in accordance with the present disclosure, including a seat base configured to couple to a vehicle seat and a juvenile seat configured to attach to the seat base, and further showing that the seat base includes a seat-base foundation and a seat-orientation controller or otherwise termed a “mounting assembly” which is coupled to the seat-base foundation and configured to mount the juvenile seat to the seat base and provide rotation and recline functions for the juvenile seat;

FIG. 2 is a cross section of the seat base taken along line 2-2 in FIG. 1 showing that the seat-orientation controller is mounted to the seat-base foundation for rotation about a rotation axis relative to the seat-base foundation;

FIG. 3 is an enlarged view of a portion of FIG. 2 showing that the seat-orientation controller is mounted to an attachment post to establish the rotation axis of the seat-orientation controller and the juvenile seat;

FIG. 4 is a perspective view with portions of the seat-orientation controller separated from the seat-base foundation to show that the seat orientation controller includes a rotation-guide pedestal received within a pedestal-receiving space formed in the seat-base foundation and a juvenile-seat attachment unit coupled to an upper end of the rotation-guide pedestal and used to mount the juvenile seat to the seat base, and further showing that the attachment unit includes an attachment body, a retainer unit coupled to an upper end of the attachment body to mount the juvenile seat to the attachment body, and a seat-motion blocking unit configured to block movement of the juvenile seat relative to the seat-base foundation;

FIG. 5 is an enlarged portion of FIG. 4 showing a rear-end seat motion blocker, included in the seat-motion blocking unit, positioned at a rear end of the attachment body;

FIG. 6 is an enlarged portion of FIG. 4 showing a controller support included in the seat-base foundation and configured to interlock with the rear-end seat-motion blocker to block forward pivoting of the juvenile seat in a forward-facing orientation;

FIG. 7 is an enlarged view of a portion of FIG. 4 showing a front-end seat motion blocker, included in the seat-motion blocking unit, positioned at a front end of the attachment body;

FIG. 8 is an enlarged view of a portion of FIG. 4 showing a juvenile-seat rotation latch, included in the seat-base foundation, and mounted at a front end of the seat-base foundation and configured to engage one of the front-end seat motion blocker and the rear-end seat motion blocker to block the juvenile seat from rotating about the rotation axis;

FIG. 9 is an exploded assembly view of the seat-orientation controller showing that the attachment body of the seat-orientation controller includes a support frame and a juvenile-seat recline unit coupled to the support frame to allow the juvenile seat to change a recline orientation relative to the support frame and the seat-base foundation;

FIG. 10 is another exploded assembly view of the attachment body;

FIG. 11 is a top plan view of portions of the attachment body showing the recline unit unactuated and in a locked state blocking recline of the juvenile seat;

FIG. 12 is a top plan view similar to FIG. 11 showing an actuator handle of the recline unit actuated to change a pair of retractable pins from the locked state to an unlocked state so that the juvenile seat is free to recline relative to the support frame and the seat-base foundation;

FIG. 13 is a perspective view of the seat base showing the recline unit in a first reclined position about a horizontal pivot axis located above the seat-orientation controller;

FIG. 14 is an enlarged view of a portion of FIG. 13 showing that the seat-orientation controller further includes a circumferential motion blocker in an extended position to block rotation of the seat-orientation controller about the vertical rotation axis all the way to the forward-facing orientation until the seat-orientation controller is moved to a predetermined recline position;

FIG. 15 is another perspective view similar to FIG. 13 showing the recline unit in a second reclined position corresponding to the predetermined recline position;

FIG. 16 is an enlarged view of a portion of FIG. 15 showing the circumferential motion blocker in a retracted position after the recline unit has assumed to the second recline position to withdraw the circumferential motion blocker away from a rotation stop fixed to the seat-base foundation;

FIG. 17 is another perspective view similar to FIG. 15 showing the seat-orientation controller rotated to a position corresponding with the forward-facing orientation of the juvenile seat;

FIG. 18 is an enlarged view of a portion of FIG. 17 showing the circumferential motion blocker aligned with the rotation stop after being withdrawn away from the rotation stop so that the seat-orientation controller is free to rotate to the position shown in FIG. 17;

FIG. 19 is a cross section taken along line 19-19 in FIG. 17 showing a latch received in a latch opening to lock the juvenile seat in a selected recline position;

FIG. 20 is another cross section of a portion of the seat base showing a projection coupled to the attachment body and engaged with the circumferential motion blocker to translate the circumferential motion blocker away from the rotation stop in response to the juvenile seat moving to an upright position for the forward-facing orientation;

FIG. 21 is a perspective view showing the juvenile seat separated from the seat base to expose a first juvenile-seat support coupled to the juvenile seat and a second juvenile seat support coupled to the seat-base foundation and configured to interlock with the first juvenile seat support only after being freed to rotate to the forward-facing orientation by adjusting the recline position of the juvenile seat to the position shown in FIG. 17;

FIG. 22 is a perspective view of the seat base showing the seat-orientation controller in a sideways orientation to expose a vehicle seatbelt retainer included in the seat base and pivotable to an unclamped position when the seat-orientation controller is in the sideways orientation;

FIG. 23 is a perspective view similar to FIG. 22 showing the vehicle seatbelt retainer pivoted relative to the seat-base foundation to a clamped position to clamp a vehicle seatbelt to the seat-base foundation;

FIG. 24 is a perspective view of a second embodiment of a child restraint with the seat removed;

FIG. 25 is a perspective view of a child restraint of FIG. 24 with the orientation controller and shell of the base removed;

FIG. 26 is a detailed perspective view of the second juvenile-seat rotation latch;

FIG. 27 is a detailed perspective view of the second juvenile-seat rotation latch;

FIG. 28 is a detail side cross sectional view showing the second juvenile-seat rotation latch in a locked position;

FIG. 29 is a detail side cross sectional view showing the second juvenile-seat rotation latch in an unlocked position;

FIG. 30 is a detailed perspective view of the second juvenile-seat rotation latch and the orientation controller;

FIG. 31 is a detailed perspective view of the second juvenile-seat rotation latch and the orientation controller;

FIG. 32 is a perspective view of the second juvenile-seat rotation latch element;

FIG. 33 is a perspective view of the first juvenile-seat rotation latch;

FIG. 34 is a perspective view of the first juvenile-seat rotation latch;

FIG. 35 is a rear view of the seat;

FIG. 36 is a perspective view of the seat;

FIG. 37 is a perspective view of the rear-end retainer of the orientation controller;

FIG. 38A is a perspective view of the rear-end retainer in a latched position;

FIG. 38 is a perspective cross sectional view of the rear-end retainer in a latched position;

FIG. 39 is a perspective cross sectional view of the rear-end retainer in an unlatched position;

FIG. 40 shows the underside of the orientation controller with the cover removed to show the latch unlocking mechanism;

FIG. 41 is a perspective view of the front-end retainer on the orientation controller and bars on the outside of the seat bottom;

FIG. 42 is a perspective view of the front-end retainer on the orientation controller and showing the front end latch element;

FIG. 43A is a perspective view of the front-end retainer on the orientation controller;

FIG. 43 is a perspective view of the front-end retainer on the orientation controller and showing the front end latch element and actuator plate;

FIG. 44 is a detailed perspective view of the front-end retainer latch element showing the biasing element;

FIG. 45 is a perspective view of a third embodiment of a child restraint with the seat and the orientation controller removed;

FIG. 46 is a perspective view of a second juvenile-seat rotation latch element including ramps;

FIG. 47 is another perspective view of the second juvenile-seat rotation latch element including ramps;

FIG. 48 is a side view of a locking portion and ramp of the second juvenile-seat rotation latch element;

FIG. 49 is a cross sectional view of the element of FIG. 48

FIG. 50 is a partial exploded view of the locking portion and ramp of the second juvenile-seat rotation latch element as shown in FIG. 46;

FIG. 51 is a perspective view of the seat belt retainer;

FIG. 52 is an exploded view of the seat belt retainer;

FIG. 53 shows the seat belt retainer with the top cover removed.

FIG. 54 is a part-perspective, part-cross sectional view of one arm of the seat belt retainer, the locking portion and the ramp of the second juvenile-seat rotation latch element, viewed from the pivot end toward the handle end; and

FIG. 55 is a side view showing the connection point for the top tether strap on the restraints of the first and second embodiments.

### DETAILED DESCRIPTION

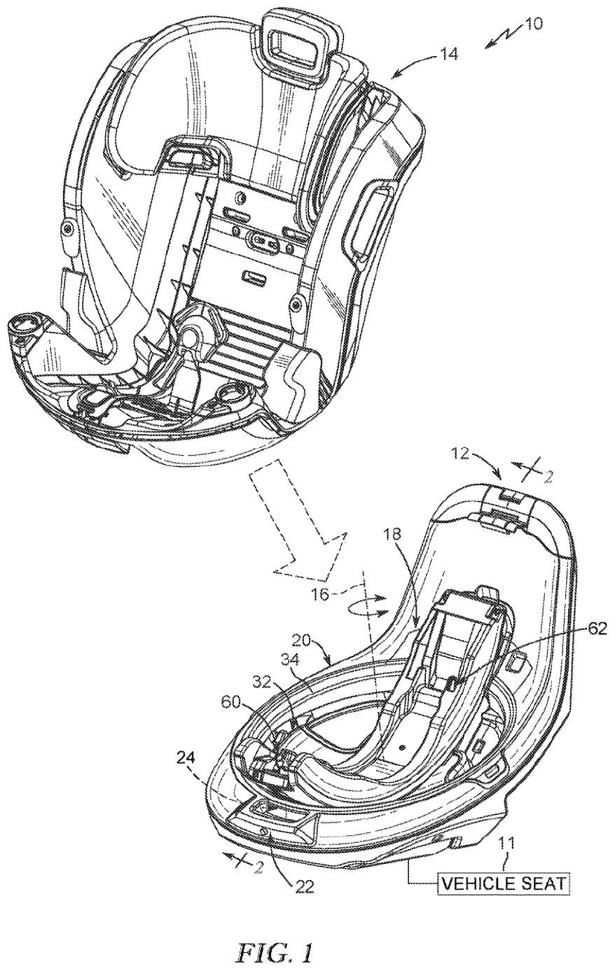

In a first embodiment, a child restraint 10 includes a seat base 12 configured to rest on a vehicle seat 11 and a juvenile seat 14 configured to mount to the seat base 12 to secure the juvenile seat 14 to the vehicle seat 11 as shown in FIG. 1. The juvenile seat 14 is rotatable relative to the seat base 12 about a generally upwardly extending rotation axis 16 to arrange the juvenile seat 14 in a forward-facing orientation or a rearward-facing orientation. It will be understood that the forward-facing orientation and a rearward-facing orientation of the seat (and the seat-orientation controller) is defined with reference to a vehicle in which the vehicle seat is arranged such that a person seated on the vehicle seat faces in the direction of forward travel of the vehicle. In illustrative embodiments, the child restraint 10 further includes a seat-orientation controller 18 (also referred to as mounting assembly 18 in other parts of the specification) that is configured to mount the juvenile seat 14 to the seat base 12 and control movement of the juvenile seat 14 relative to the seat base. The seat-orientation controller 18 is fixed to the seat base 12 and is rotatable about the vertical rotation axis 16 in unison with the juvenile seat 14 when the juvenile seat 14 is mounted on the seat-orientation controller 18. The seat orientation controller 18 includes features that allow the juvenile seat to rotate and recline relative to the seat base 12.

The seat base 12 includes a seat-base foundation 20, a release handle 22 coupled to the seat base at a front edge of a lower portion 26 of the base, and a first juvenile-seat rotation latch 24 coupled to the release handle 22 to move therewith as shown in FIGS. 1 and 2. The first juvenile-seat rotation latch 24 (e.g. a rotation locking mechanism) is biased into engagement with the seat-orientation controller 18 to hold or retain the juvenile seat 14 in one of the forward-facing orientation and the rearward-facing orientation.

In a second embodiment discussed further below, the seat base 12 includes a second juvenile-seat rotation latch which is disposed in an upper portion 28 of the seat base. Rotation of the orientation controller (e.g. mounting assembly) and the seat is thereby restricted. In a further embodiment, the first juvenile-seat rotation latch may be omitted. The rotation of the seat is then retained in the forward or rearward facing orientation by the second juvenile-seat rotation latch alone.

The seat base foundation 20 includes a foundation bottom 26 (also referred to as lower portion 26) and a foundation backrest 28 (also referred to as upper portion 28) coupled to the foundation bottom 26 and arranged to extend upwardly away from the foundation bottom 26 as shown in FIGS. 1 and 2. In some embodiments, the foundation backrest 28 may be omitted. The foundation bottom 26 includes a concave, foundation basin 30 defining a controller-receiving space 32, a perimeter rim 34 coupled to the foundation basin 30, and a controller support 36 coupled to a rear end of the perimeter rim 34. The seat-orientation controller 18 is at least partially received within the controller-receiving space 32. The perimeter rim 34 is coupled to an upper end of the foundation basin 30 and is arranged to extend circumferentially around the foundation basin 30 and the vertical rotation axis 16. The perimeter rim 34 is substantially circular in the illustrative embodiment. The controller support 36 is configured to interact with the seat-orientation controller 18 in both the forward-facing orientation and the rearward-facing orientation to block upward movement of the seat-orientation controller 18, and the juvenile seat 14 fixed thereto, relative to the seat base-foundation 20. The orientation controller 18 is thus at least partially prevented from moving upwardly away from the base by the controller support 36.

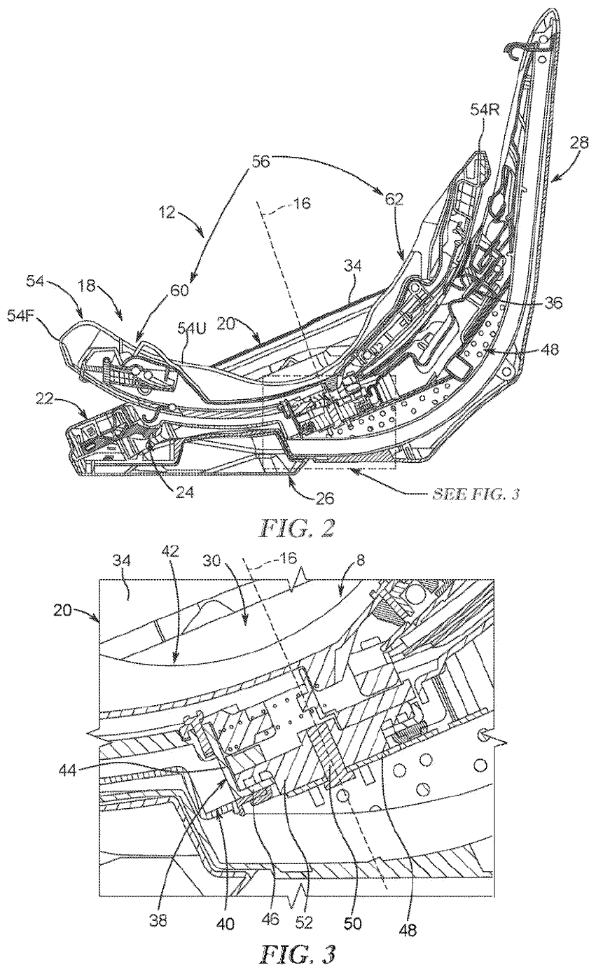

The seat-orientation controller 18 includes a rotation-guide pedestal 38 received within a pedestal-receiving space 40 formed in the foundation basin 30 and a juvenile-seat attachment unit 42 coupled to the rotation-guide pedestal 38 as shown in FIGS. 2 and 3. The rotation-guide pedestal 38 is generally cylindrical and is arranged along the generally upwardly extending rotation axis 16. The juvenile seat 14 is configured to attach to the juvenile-seat attachment unit 42 to mount the juvenile seat 14 to the seat base 12.

The rotation-guide pedestal 38 includes a side wall 44 that is substantially parallel to the rotation axis 16 and a retainer ring 46 coupled to a lower end of the side wall 44 and that extends radially inward toward the vertical rotation axis 16 as shown in FIG. 3. The seat-base foundation 20 further includes a rigid support frame 48, an attachment post 50 coupled to the rigid support frame 48, and a bearing disk 52 coupled to the attachment post 50. The attachment post 50 is arranged along and provides the rotation axis 16. The retainer ring 46 is arranged to lie vertically between the bearing disk 52 and an upper surface of the seat-base foundation 20 to at least partially block movement of the seat-orientation controller 18 away from the seat-base foundation 20 along the rotation axis 16. The retainer ring 46 is rotatable relative to the bearing disk 52. A plurality of balls (not shown) may be located between the retainer ring 46 and the bearing disk 52 and/or between the retainer ring 46 and the upper surface of the seat-base foundation 20 to reduce friction therebetween.

The juvenile-seat attachment unit 42 of the orientation controller (i.e. the mounting assembly) includes an attachment body 54, a seat-retainer unit 56 coupled to the attachment body 54, and a motion-blocking unit 58 configured to block movement of the seat-orientation controller 18 relative to the seat base 12 when the juvenile seat 14 is in the forward-facing orientation and/or the rearward-facing orientation. The attachment body 54 has a curved shape and is arranged to lie at least partially within the controller-receiving space 32 and to generally follow the concave shape of the foundation basin 30 defining the controller-receiving space 32. The seat-retainer unit 56 is configured to attach and retain the juvenile seat 14 to the attachment body 54. The motion-blocking unit 58 cooperates with the first juvenile-seat retainer latch 24 to block circumferential rotation of the seat-orientation controller 18 relative to the seat base 12. The motion-blocking unit 58 also cooperates with the controller support 36 to block forward pivoting of the seat-orientation controller 18 relative to the seat base 12 during a front impact, for example.

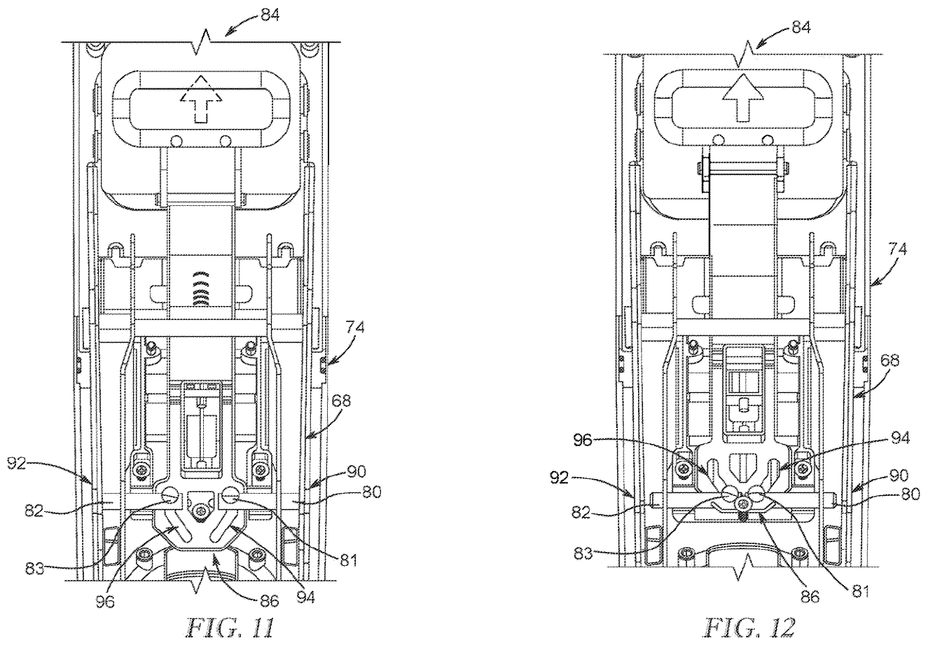

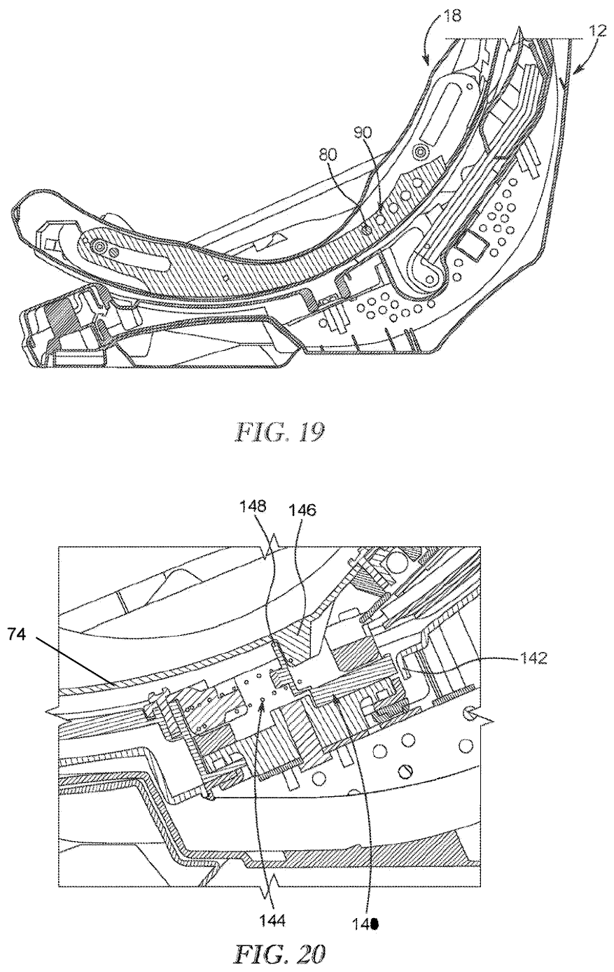

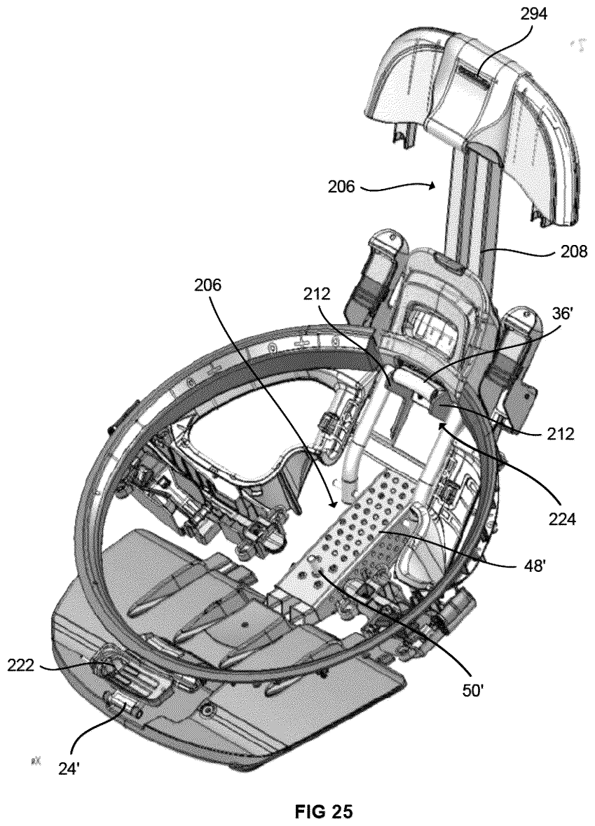

The seat-retainer unit 56 includes a front-end seat retainer 60 and a rear-end retainer 62 as shown in FIGS. 1 and 2. The retainers 60 and 62 may also be referred to in this specification as a catch. In the first embodiment, only the front-end retainer 60 latches the juvenile seat to the seat orientation controller 18. The rear-end controller does not latch or lockingly engage with the juvenile seat. Rather, a (see bar 234 in the second embodiment of FIG. 25 for instance) on the seat sits within the rear-end retainer 62. The front-end seat retainer 60 is arranged to lie on the upper end 54U of the attachment body 54 and at a front end 54F of the attachment body 54. The rear-end seat retainer 62 is arranged to lie on the upper end 54U of the attachment body 54 and at a rear end 54R of the attachment body 54. In the embodiment depicted in FIGS. 1 to 23, the forward seat retainer 60 is configured to secure the juvenile seat 14 to the juvenile-seat attachment unit 42 and allow selective separation of the juvenile seat 14 from the juvenile-seat attachment unit 42.

In a second embodiment, the forward seat retainer 60′ and the rear seat retainer 62′ are both configured to provide locking engagement between the juvenile seat 14′ to the juvenile-seat attachment unit 42′ and allow selective separation of the juvenile seat 14′ from the juvenile-seat attachment unit 42′.

It will be appreciated that in the context of the forward and rear seat retainers, the nomenclature ‘forward’ and ‘rear’ is in relation to the seat. For example, the front of the seat is the direction that the child is facing and the rear of the seat is the portion behind the child's back.

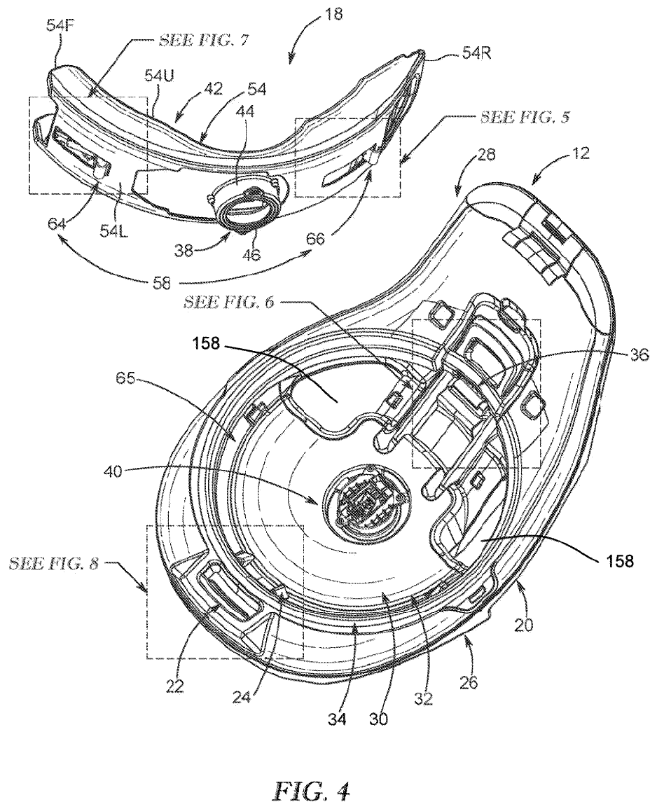

The motion-blocking unit 58 of the motion controller (e.g. mounting assembly) includes a first seat-motion blocker 64 (e.g. a motion blocker portion) and a second seat-motion blocker 66 as shown in FIGS. 4-8. The first seat-motion blocker 64 is coupled to a lower end 54L of the attachment body 54 at the front end 54F of the attachment body 54. The second seat-motion blocker 66 is coupled to the lower end 54L of the attachment body 54 at the rear end 54R of the attachment body 54. The first seat-motion blocker 64 sits underneath the controller support 36 when the juvenile seat 14 is in the rearward-facing orientation. The first seat-motion blocker 64 is retained by the first juvenile-seat retainer latch 24 when the juvenile seat 14 is in the forward-facing orientation. In a second embodiment, the second seat-motion blocker 66 is retained by the second juvenile-seat retainer latch 224 when the juvenile seat 14 is in the forward-facing orientation. The second seat-motion blocker 66 sits underneath the controller support 36 when the juvenile seat 14 is in the forward-facing orientation. The second seat-motion blocker 66 is retained by the first juvenile-seat retainer latch 24 when the juvenile seat 14 is in the rearward-facing orientation. Thus, in the second embodiment, the first seat-motion blocker 64 is retained by the second juvenile-seat retainer latch 224 when the juvenile seat 14 is in the rearward-facing orientation.

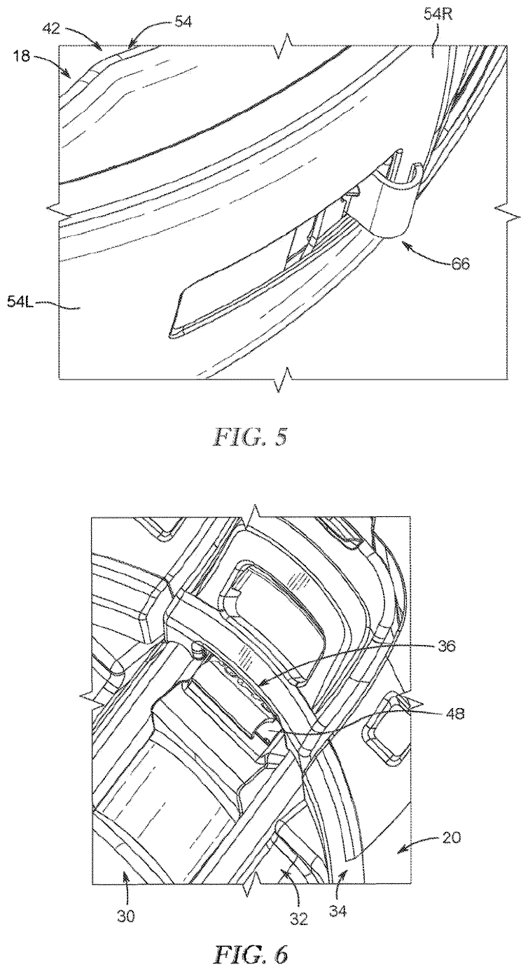

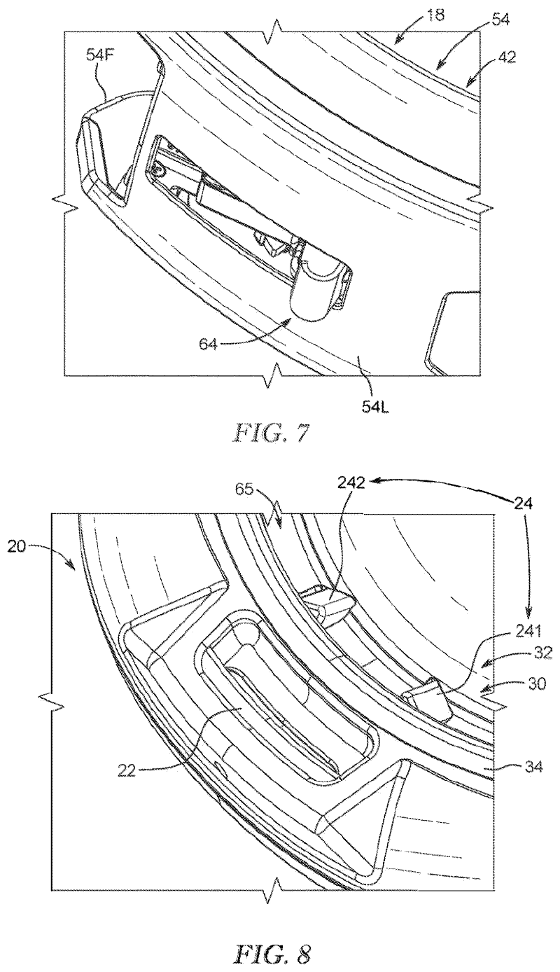

Each of the first and second seat-motion blockers 64, 66 has a J-shaped profile when viewed from the side as shown in FIGS. 5 and 7. The controller support 36 also has a complementary J-shaped profile when viewed from the side as shown in FIG. 6. The controller support 36 is fixed to the rigid support frame 48 of the seat-base foundation 20 to bear loads acting on controller support 36 from one of the seat motion blockers 64, 66.

Each of the seat-motion blockers 64, 66 travel in a blocker pathway 65 which extends circumferentially around axis 16 and below the perimeter rim 34. The first juvenile-seat retainer latch 24 and the controller support 36 are each aligned and reside at least partially with the blocker pathway 65. In the second embodiment, the second juvenile-seat retainer latch 224 is also aligned and resides at least partially with the blocker pathway 65. The first and second seat-motion blockers 64, 66 align with the controller support 36 and the first (and second) juvenile-seat retainer latches 24 in both the forward-facing orientation and the rearward-facing orientation. The first and second seat-motion blockers 64, 66 interlock with the controller support 36 by passing under the controller support 36 when the seat-orientation controller 18 reaches the forward-facing orientation and the rearward-facing orientation.

As shown in FIG. 8 and FIG. 34, the first juvenile-seat retainer latch 24 includes a pair of opposing latch ramps 241, 242 which are inclined circumferentially toward one another. The ramps 241, 242 are biased to extend into the controller-receiving space 32 and are retractable from the controller-receiving space 32 in response to one of the seat-motion blockers 64, 66 impacting one of the ramps 241, 242 as the seat-orientation controller 18 rotates about axis 16. Once one of the seat-motion blockers 64, 66 is arranged to lie between the ramps 241, 242, the seat-orientation controller 18 is at least partially blocked from rotating about axis 16 by the ramps 241, 242. The release handle 22 is coupled to both ramps 241, 242 and retracts the ramps 241, 242 from the controller-receiving space 32 when actuated by a user to free the seat-orientation controller 18 to rotate about the axis 16. The release handle 22 is pivotally mounted to the base 12 at the end 23 of the release handle 22 opposite the ramps 241, 242. The ramps 241, 242 move downwards as the release handle 22 pivots when a user depresses the midpoint of the release handle 22.

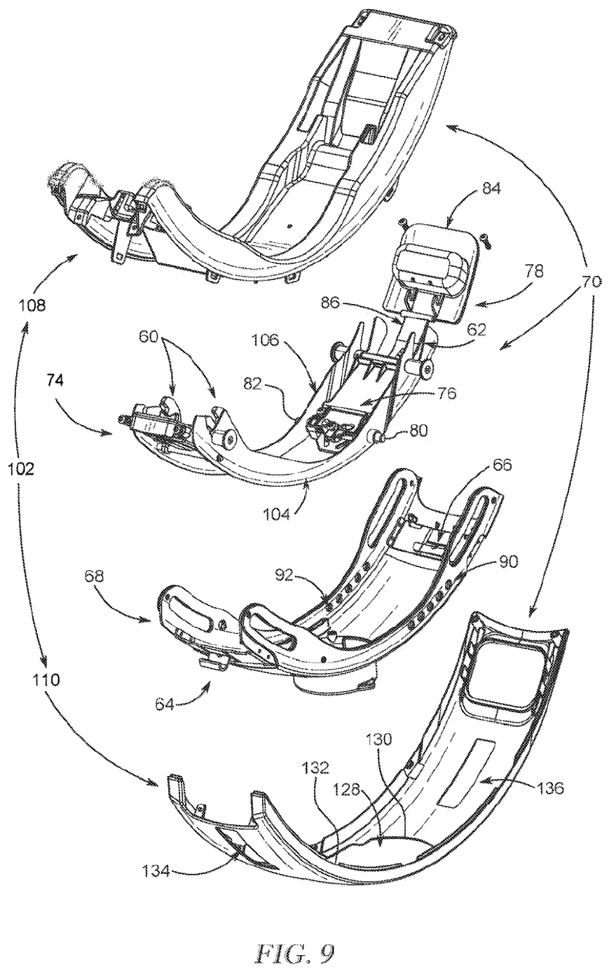

As shown in FIG. 9, the attachment body 54 of the seat-orientation controller 18 includes a support frame 68 coupled to the rotation-guide pedestal 38 in a fixed position, and a juvenile-seat recline unit 70 coupled to the support frame 68 as shown in FIG. 9. The support frame 68 is rotatable about the rotation axis 16 but does not pivot (in the reclining sense) relative to the seat base 12. The juvenile-seat recline unit 70 is configured to move relative to the support frame 68 and the seat base 12 about a horizontal pivot axis 72 (FIG. 13) located above the seat-orientation controller 18 to change the juvenile seat 14 from a first reclined position relative to the seat-base foundation 20 to a second reclined position relative to the seat-base foundation 20. The second reclined position has a different orientation relative to the vertical rotation axis 16 than the first reclined position such that the juvenile seat 14 can adjust a recline angle relative to the rotation axis 16 when the juvenile seat 14 is in the rearward-facing orientation.

The juvenile-seat recline unit 70 includes a movable recline carriage 74 (also called a recline unit), a recline lock 76 coupled to the movable recline carriage 74 for movement therewith, and a recline-lock actuator 78 coupled to the recline lock 76 as shown in FIG. 9. The recline lock 76 is coupled releasably to the support frame 68 so that the movable recline carriage 74 can pivot relative to the support frame 68 when the recline lock 76 is released from the support frame 68. The recline-lock actuator 78 is configured to be engaged by a user to move the recline lock 76 from a locked position to an unlocked position. In the locked position, the recline lock 76 extends between and interconnects the movable recline carriage 74 and the support frame 68 to block movement of the movable recline carriage 74 relative to the support frame 68. In the unlocked position, the recline lock 76 is separated from the support frame 68 and the movable recline carriage 74 and the juvenile seat 14 attached thereto is free to move about the horizontal pivot axis 72 relative to the support frame 68 and the seat base 12.

The recline lock 76 includes a first movable latch 80 and a second movable latch 82 each biased toward the support frame 68 to normally establish the locked position. The movable latches 80, 82 each extend into corresponding latch openings 90, 92 formed in the support frame 68 in the locked position. The recline lock further includes a latch mount 88 that receives guide pins 81, 83 coupled to each respective movable latch 80, 82 to guide translation of the movable latches 80, 82 relative to the latch mount 88 when the recline-lock actuator 78 is engaged. There are a plurality of latch openings 90, 92 in the support frame 68 which each correspond to a different recline position for the juvenile seat 14.

The recline-lock actuator 78 includes an actuator handle 84 configured to be gripped by a user and a latch mover 86 coupled to the actuator handle 84. The latch mover 86 is configured to be moved relative to the recline lock 76 in response to actuation of the actuator handle 84 by the user to change the first and second movable latches from the locked position to the unlocked position.

The latch mover 86 is formed to include a first latch-mover slot 94 that receives a latch guide pin 81 of the first movable latch 80 and a second latch-mover slot 96 that receives a latch guide pin 83 of the second movable latch 82. The first latch-mover slot 94 is arranged to lie at least partially at an angle relative to a direction of travel of the first movable latch 80. The second latch-mover slot 96 is arranged to lie at least partially at an angle relative to a direction of travel of the second movable latch 82. The latch mover 86 is configured to withdraw the first and second movable latches 80, 82 from opposing first and second latch openings 90, 92 formed in the support frame 68 to separate the first and second movable latches 80, 82 from the support frame 68 so that the movable recline carriage 74 is free to pivot about the horizontal pivot axis 72 relative to the support frame 68.

The first and second guide slots 94, 96 are at least partially angled toward one another to cause the first and second movable latches 80, 82 to be withdrawn toward one another. The first and second movable latches 80, 82 move toward one another as the latch mover 86 is actuated.

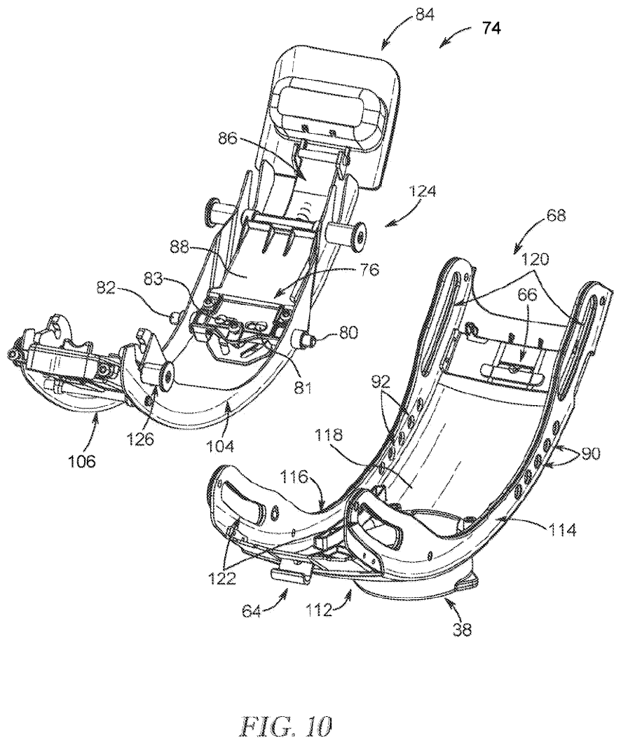

The juvenile-seat recline unit 70 includes a carriage housing 102 (parts 108 and 110) surrounding the recline lock 76, the recline-lock actuator 78, and a portion of the support frame 68 as suggested in FIGS. 9 and 10. The movable recline carriage 74 further includes a first recline-lock carrier beam 104 arranged to lie on a first side of latch mover 86 and coupled to the first movable latch 80 and a second recline-lock carrier beam 106 arranged to lie on an opposite, second side of the latch mover 86 and coupled to the second movable latch 82. The carriage housing 102 includes a top cover 108 and a bottom cover 110, both of which are configured to pivot about the horizontal pivot axis 72. The seat-retainer unit 56 including the front-end retainer 60 and the rear-end retainer 62 are both fixed to the first and second recline-lock carrier beams 108, 110 for pivotable movement about the horizontal pivot axis 72 with the carriage housing 102.

The support frame 68 includes a frame base 112, a first support beam 114 coupled to the frame base 112 and to a first side of the juvenile-seat recline unit 70, and a second support beam 116 coupled to the frame base 112 and an opposite, second side of the juvenile-seat recline unit 70. The first and second seat motion blockers 64, 66 are fixed to the frame base 112 and extend downwardly therefrom. The first support beam 114 and the second support beam 116 extend longitudinally along an entire length of the frame base 112 and extend upwardly therefrom.

The frame base 112 includes a curved base plate 118 coupled to both the first and the second support beams 114, 116 and the rotation-guide pedestal 38 that extends downwardly from the curved base plate 118 and that is secured to the seat base 12 to establish the vertical rotation axis 16. The first support beam 114 and the second support beam 116 are each formed to include a first guide slot 120 and a second guide slot 122 spaced apart from the first guide slot 120. The juvenile-seat recline unit 70 further includes a first guide pin 124 that extends through the first guide slot 120 formed in both of the first and second support beams 114, 116 and a second guide pin 126 that extends through the second guide slot 122 formed in both of the first and second support beams 114, 116. The first support beam 114 and the second support beam 116 are each formed to include the plurality of latch openings 90, 92 between the first and second guide slots 120, 122.

The bottom cover 110 of the carriage housing 102 is formed to include a pedestal-receiving opening 128 as shown in FIG. 9. The carriage housing 102 is configured to move relative to the rotation-guide pedestal 38 between the first reclined position and the second recline position such that a first end 130 of the pedestal-receiving opening 128 is closer to the rotation-guide pedestal 38 in the first reclined position and an opposite, second end 132 of the pedestal-receiving opening 128 is closer to the rotation-guide pedestal 38 in the second reclined position than the first end 130. Seat motion-blockers 64, 66 are also received in corresponding openings 134, 136 formed in the bottom cover 110 of the carriage housing 102.

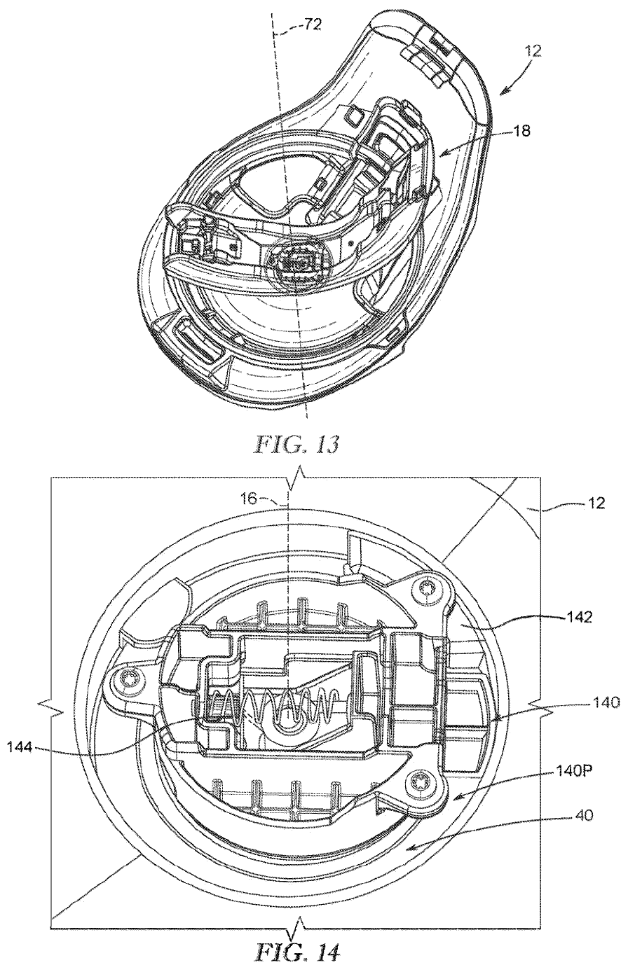

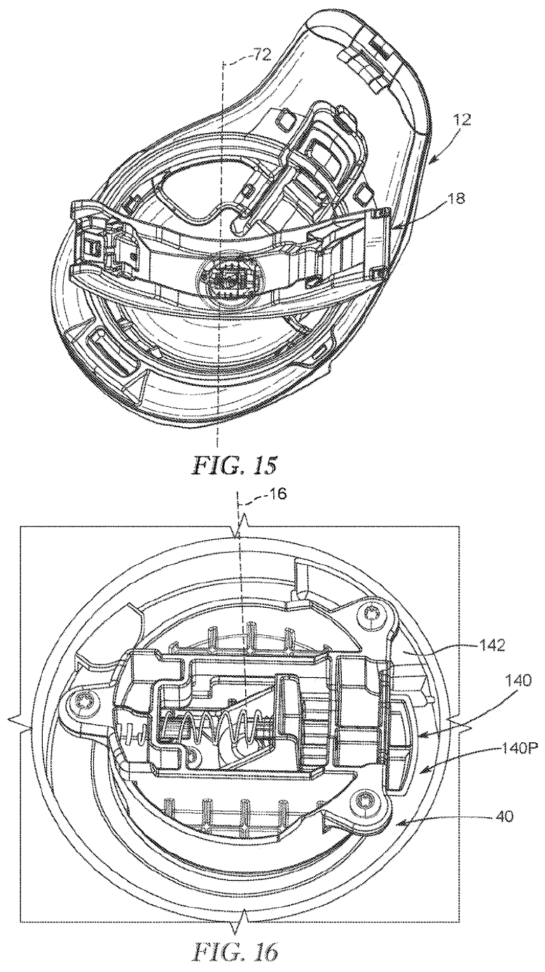

As best shown in FIGS. 14, 16, 18, 20, the seat-orientation controller 18 further includes a circumferential motion blocker 140 that is configured to block rotation of the seat-orientation controller 18 about the rotation axis 16 all the way to the forward-facing orientation until the seat-orientation controller 18 is moved to a predetermined recline position as suggested in FIGS. 13-18. The circumferential motion blocker 140 is received in the pedestal-receiving space 40 and is movable between an extended position, as shown in FIG. 14, and a retracted position, as shown in FIG. 16, depending on the recline position of the seat-orientation controller 18. The circumferential motion blocker 140 is configured to slide relative to the seat base 12 and the support frame 68 between the extended position and the retracted position as shown in FIGS. 14 and 16.

In the extended position, the circumferential motion blocker 140 protrudes into a travel path 140P positioned radially outward from the rotation guide pedestal 38 relative to the vertical rotation axis 18. The seat base 12 includes a rotation stop 142 that is fixed in position relative to the seat-orientation controller 18 and that extends into the travel path 140P from a rear end of the pedestal-receiving space 40. The circumferential motion blocker 140 will engage the rotation stop 142 if the seat-orientation controller 18 attempts to rotate to the forward-facing orientation when the circumferential motion blocker 140 is in the extended position as suggested in FIG. 14.

A portion of the juvenile-seat recline unit 70 is configured to engage and move the circumferential motion blocker 140 from the extended position to the retracted position in response to changing the recline position of the seat-orientation controller 18 as suggested in FIGS. 13-16. In the retracted position, the circumferential motion blocker 140 is withdrawn from the travel path 140P as shown in FIG. 16. Once withdrawn from the travel path 140P, the circumferential motion blocker 140 is free to rotate past the rotation stop 142 and the seat-orientation controller 18 can assume the forward-facing orientation as shown in FIGS. 17 and 18.

The circumferential motion blocker 140 is biased to the extended position by a spring 144 as shown in FIGS. 14 and 16. The juvenile-seat recline unit 70 further includes a motion-blocker mover 146 (see FIG. 20). The motion-blocker mover 146 is coupled to the recline carriage 74 and extends toward the circumferential motion blocker 140. The motion-blocker mover 146 is configured to engage an upwardly-extending lip 148 of the circumferential motion blocker 140 when the seat-orientation controller 18 is moved to a reclined position as shown in FIGS. 17, 19, and 20. In the reclined position, the latches 80, 82 are received in lowermost/forwardmost openings of the plurality of openings 90, 92 and the circumferential motion blocker 140 has been moved by the motion-blocker mover 146 to the retracted position by engagement between the upwardly-extending lip 148 and the motion-blocker mover 146.

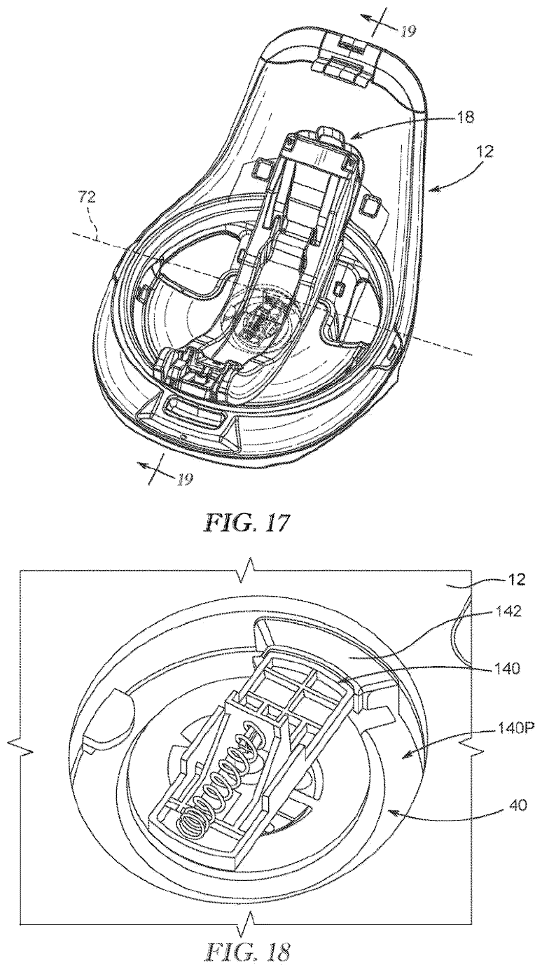

FIG. 14 illustrates the engaged position of the circumferential motion blocker 140 corresponding to the seat orientation controller 18 being in the position illustrated in FIG. 13. Likewise, FIG. 16 illustrates the engaged position of the circumferential motion blocker 140 when the seat orientation controller 18 is in the position illustrated in FIG. 15. As will be seen from a comparison of FIG. 15 with FIG. 13, the seat orientation controller 18 is in a more reclined position in FIG. 15. As will be appreciated, the more reclined position of the seat orientation controller 18, in particular the movable recline carriage 74 retracts the circumferential motion blocker 142 the retracted position illustrated in FIGS. 16 and 18 Likewise, FIG. 18 illustrates the position of the circumferential motion blocker 140 when the seat orientation controller 18. Instead of being blocked by the rotation stop 142, the circumferential motion blocker 140 bears against a curved face of the rotation stop 142. The complementary curved faces of the rotation stop 142 and circumferential motion blocker 140 will allow relative rotational movement about the axis 16.

In some embodiments, once the juvenile seat 14 assumes the reclined position and is rotated to the forward-facing orientation, the actuator handle 84 can be reengaged by a user to adjust the recline position of the juvenile seat 14.

The circumferential motion blocker 140 blocks a user from rotating the juvenile seat 14 to the forward-facing orientation until the juvenile seat 14 is in the fully reclined position.

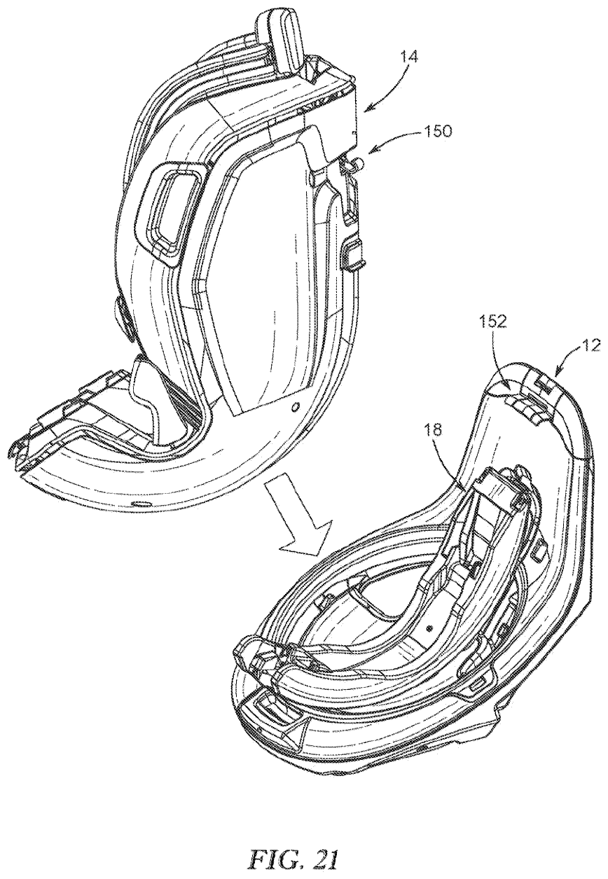

The juvenile seat 14 includes a first juvenile-seat support 150 coupled to a backside thereof as shown in FIG. 21. The juvenile seat support 150 is configured to interlock with a corresponding second juvenile-seat support 152 when the juvenile seat 14 is in the forward-facing orientation. The first juvenile-seat support 150 pivots with the juvenile seat 14 when the seat-orientation controller 18 recline position is changed. Thus, the circumferential motion blocker 140 provides the first juvenile seat support 150 is at a correct position to interlock with the second juvenile-seat support 152 before reaching the forward-facing orientation.

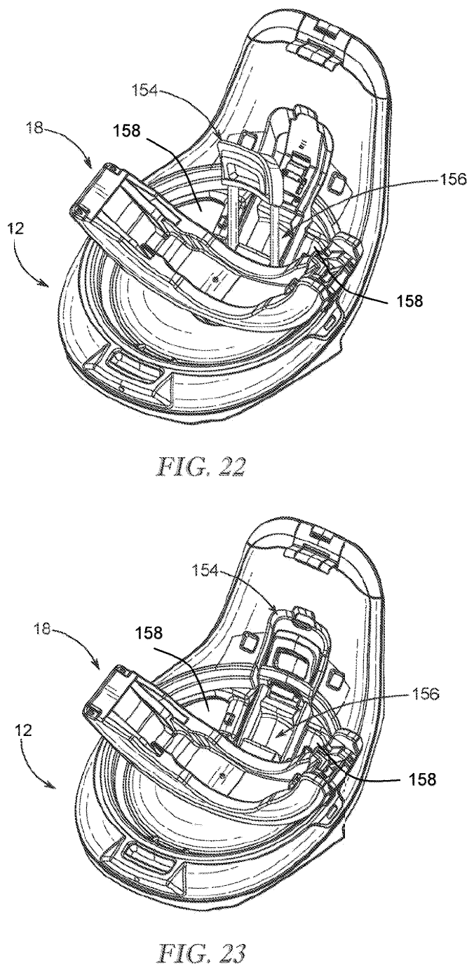

The child restraint 10 further includes a seat belt retainer 154 that is mounted to the seat base 12 and that is configured to pivot relative to the seat base 12 to open and close a belt path 156 for a vehicle seat belt as shown in FIGS. 22 and 23. The seat base includes apertures 158 (see also FIG. 4) through which a belt (not shown) can pass. The belt may be a vehicle seat belt or a belt which is secured to the ISOFIX or LATCH anchors of the vehicle seat. When the seat belt retainer 154 is in the open position, as in FIG. 22, the belt can be passed through the apertures 158 and underneath the seat belt retainer 154. When in the closed position, the belt is clamped between the seat belt retainer 154 and the seat base 12. The seat belt retainer 154 may be arranged to displace a portion of the belt to remove excess slack from the belt and provide correct tension. The seat belt retainer 154 may only be pivoted to an opened position as shown in FIG. 22 when the seat-orientation controller 18 is in a sideways facing arrangement. The seat belt retainer 154 may also only be pivoted to the opened position when the juvenile seat is removed from the seat-orientation controller 18. This may help provide that the seat base 12 is properly secured to a vehicle seat 11 prior to full installation of the juvenile seat 14. Once the belt retainer 154 is moved to a closed position as shown in FIG. 23, the seat orientation controller is free to rotate about the vertical rotation axis 16. The seat orientation controller 18 may help retain the seat belt retainer 154 in the forward-facing and rearward-facing orientations.

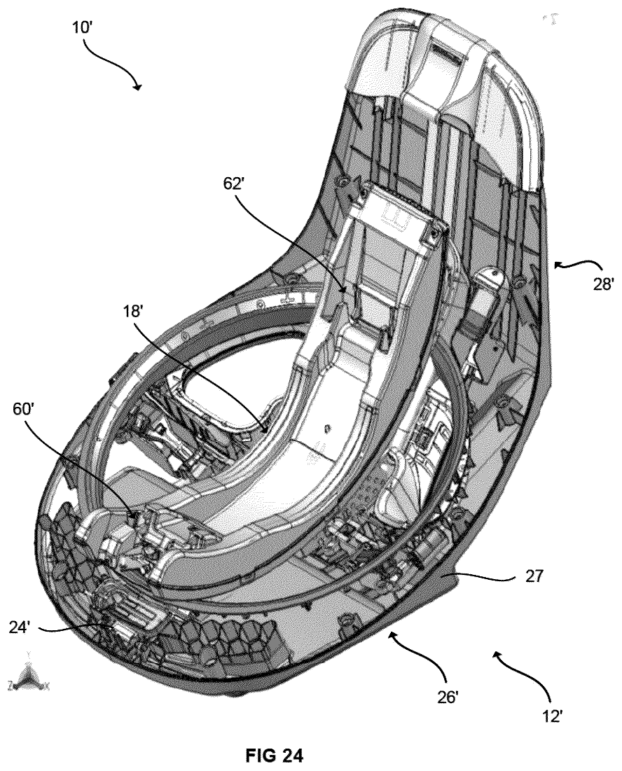

A second embodiment of a child restraint 10′ will now be discussed with reference to FIGS. 24 to 42. The second embodiment includes most of the features of the first embodiment. As discussed above where relevant, the second embodiment includes additional features relating to the second juvenile-seat rotation latch 224 and the rear-end retainer 62′. Further, in the second embodiment, the first juvenile-seat rotation latch 24′ has been modified to function as a ‘bump off’ which provides a lower resistance to the free rotation of the seat than the second juvenile-seat rotation latch 224. The first juvenile-seat rotation latch 24′ of the second embodiment is discussed in detail below. It is also contemplated that the first juvenile-seat rotation latch 24′ may remain as an unmodified rotation locking latch if desired, as in the first embodiment.

In the first embodiment, no second juvenile-seat rotation latch 224 is provided on the upper portion 28 of the base 12. Further, in the first embodiment, the rear-end retainer 62 (as shown in FIG. 1) is not provided as a catch or latch and is instead a simple groove in which the complementary feature of the seat 14 is located. The secure attachment of the seat 14′ to the seat orientation controller 18, and also the securement against rotation of the seat orientation controller 18 relative to the base may therefore be improved in the second embodiment.

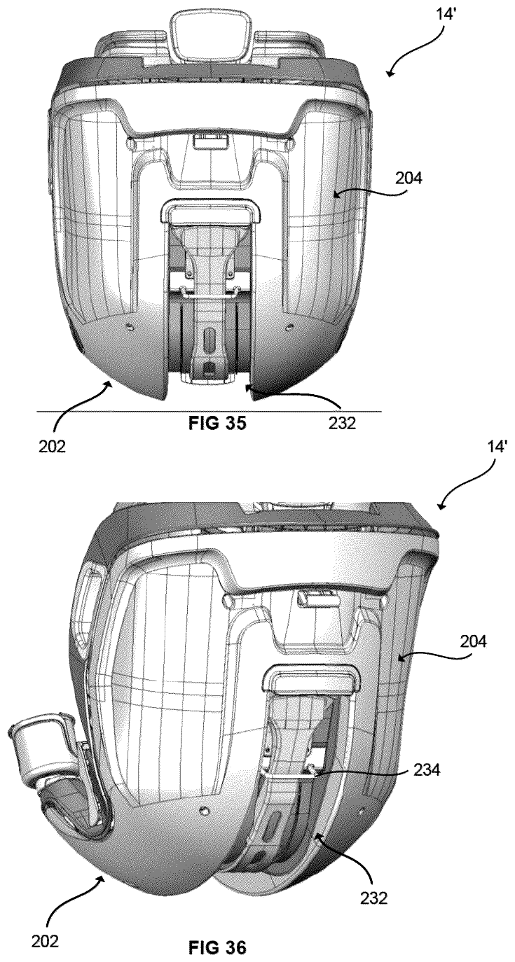

In FIG. 24, the restraint 10′ is shown with the juvenile seat 14′ removed and the seat orientation controller 18′ in the forward-facing orientation. In this second embodiment, the seat orientation controller 18′ has a first seat retainer unit 60′ which engages with a bottom portion 202 of the seat 14′ (see FIG. 36) and a second seat retainer unit 62′ which engages with a backrest portion 204 of the seat 14′. This second embodiment also includes a first juvenile-seat rotation latch 24′ and a second juvenile-seat rotation latch 224 (FIG. 25) which retain the seat orientation controller 18′ in one of two permissible selectable orientations.

FIG. 25 depicts the restraint 10′ with the seat orientation controller 18′ and outer shell 27 of the base 12′ removed for clarity. The second juvenile-seat rotation latch 224 can be seen in the upper portion 28′ of the base 12′. A support assembly 206 including a spine 208 in the form of two beams can also be seen. The support assembly 206 also includes the rigid support frame 48′ onto which the seat orientation controller 18′ can be rotatably mounted using attachment post 50′.

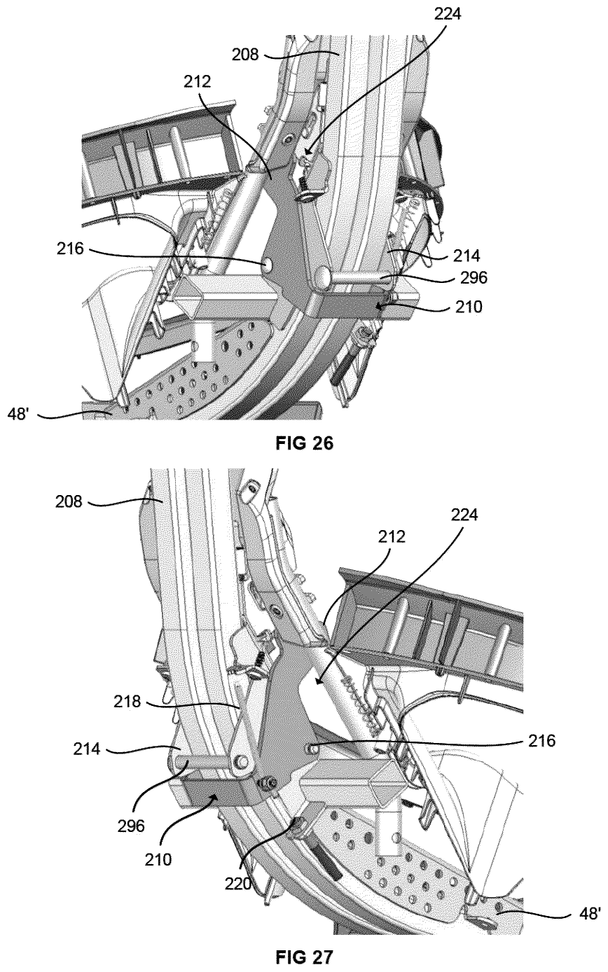

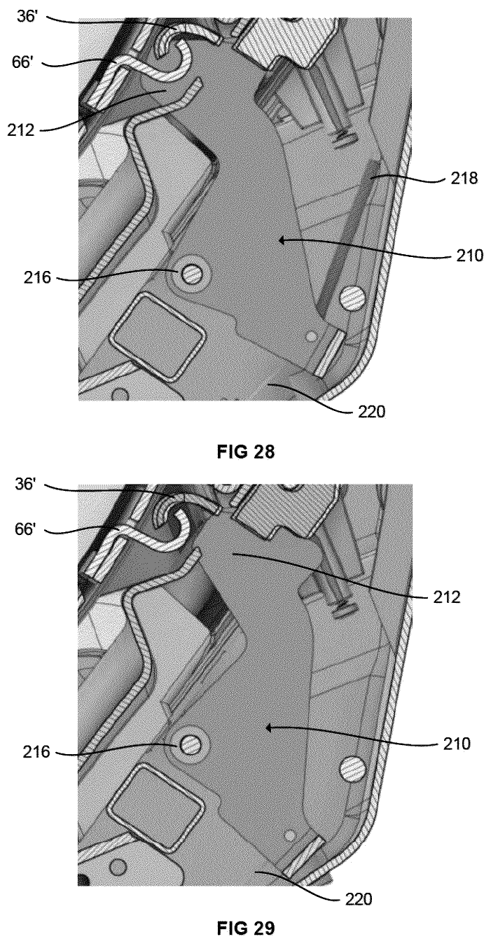

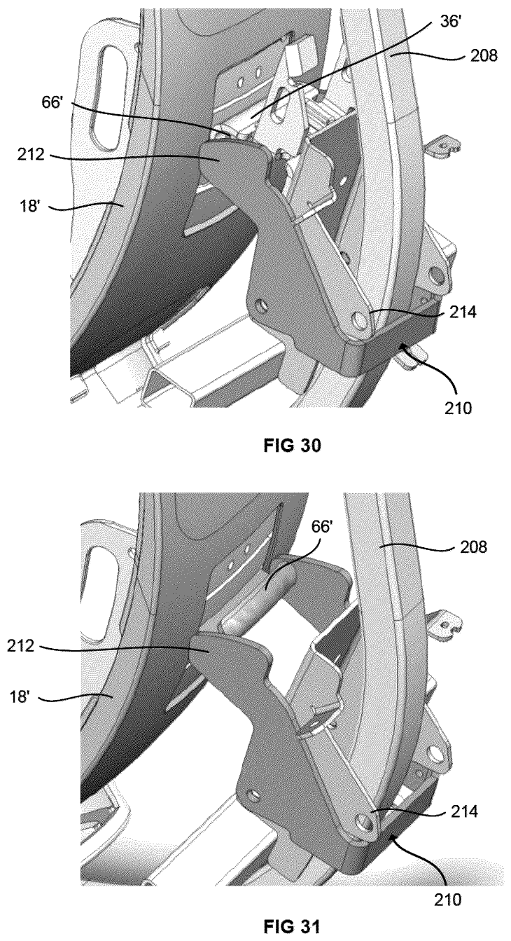

The second juvenile-seat rotation latch 224 is further shown in FIGS. 26 to 32. Turning first to FIG. 26 and FIG. 27, the second juvenile-seat rotation latch 224 includes a locking element 210 including two spaced apart locking portions 212. The locking portions 212 protrude through to the blocker pathway 65 (see FIG. 4) in the inner area of the base 12′. When the juvenile seat is in the forward orientation, the seat motion blocker 66′ (see FIG. 28) of the seat orientation controller 18′ is received between the locking portions 212 (see FIGS. 30 and 31). Conversely, when the juvenile seat is in the rearward orientation, the seat motion blocker 64′ of the seat orientation controller 18′ is received between the locking portions 212. Accordingly, the seat motion blocker 66′ or 64′ is disposed between the two spaced apart locking portions 212 when the juvenile seat is in the forward or rearward orientations which blocks the rotational (e.g. sideways) movement of the seat orientation controller 18′ about axis 16′. The controller support 36 is disposed between the locking portions 212 and above the seat motion blocker 66′ or 64′ and restricts the upward movement of the seat orientation controller 18′.

The locking element 210 is pivotably mounted to the spine 208 of the support assembly 206 via a bracket 214 at pivot points 216. The bracket 214 is fixed to the spine 208. The locking element 210 is biased by a spring 218 to the locked position as shown in FIGS. 26, 27, and 28 for example (as best shown in FIG. 28). An actuation cable 220 connects to the locking element 210 opposite the locking portions 212. When the cable 220 is pulled by operation of a sliding actuator 222 (shown in FIG. 25), the cable 220 retracts which causes the locking element 210 to rotate and thus the locking portions 212 to retract to an unlocked position, as shown in FIG. 29 (in comparison to FIG. 28). When retracted, the seat motion blocker 66′ or 64′ is no longer retained between the locking portions 212 and the seat orientation controller 18′ is free to rotate about axis 16′.

FIG. 30 is a perspective view showing the locking element in the same orientation as in FIG. 28. In FIG. 31, the controller support 36′ is removed for clarity. The seat motion blocker 66′ is positioned between the locking portions 212 of the locking element 210 to restrict sideways movement and therefore restrict rotation of the seat orientation controller 18′. The seat motion blocker 66′ is also located below the controller support 36′ to block upward movement of the seat-orientation controller 18′, and the juvenile seat 14′ fixed thereto, relative to the seat base foundation 20′.

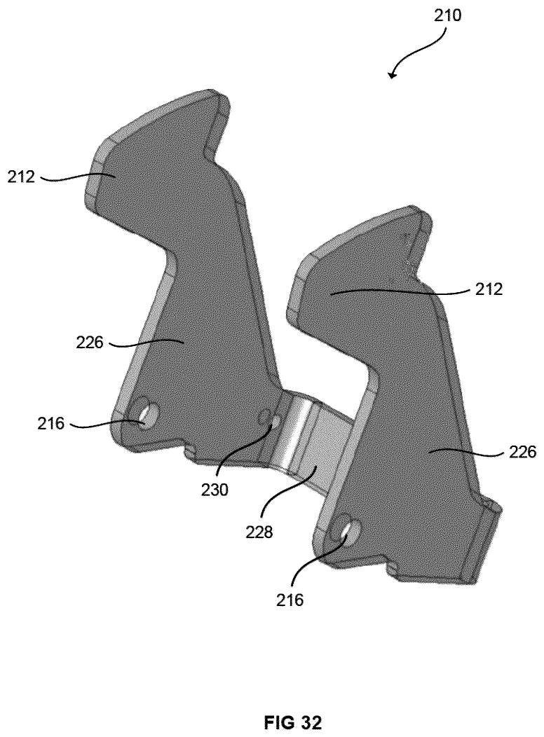

The locking element 210 is shown in isolation in FIG. 32. The locking element 210 includes the locking portions 212 which are on the ends of spaced locking arms 226. The locking arms 226 are joined by an intermediate portion 228 on an end of the arms 226 which is opposite the locking portions 212. The pivot points 216 are located on the arms 226 between the locking portions 212 and the intermediate portion 228. The actuation cable 220 and spring 218 are connected to the locking element 210 at the hole 230 located on one of the arms toward the intermediate portion 228.

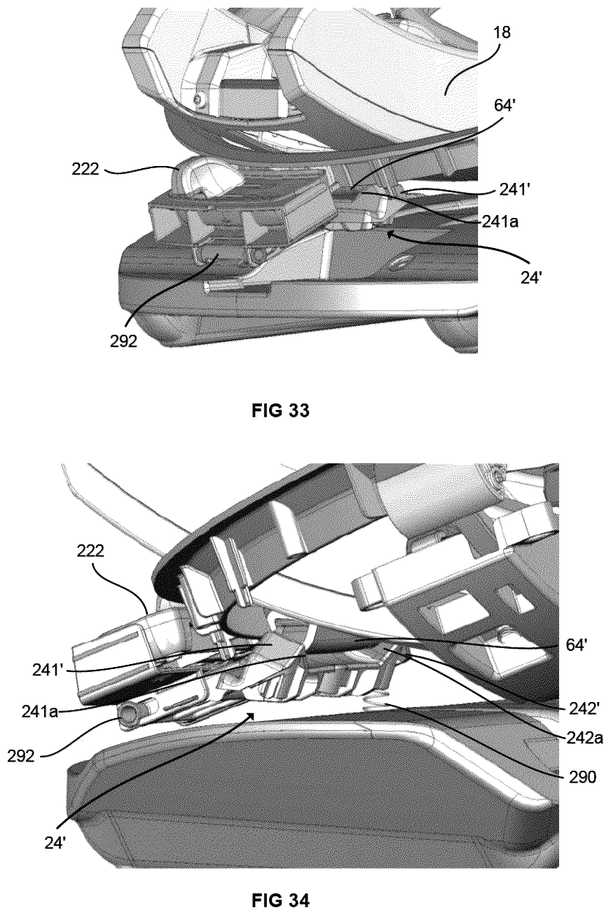

As shown in FIG. 33, the slide actuator 222 is located toward the front edge of the lower portion 26′ of the base 12′ and away from the upper portion 28′. The slide actuator 222 is operated by moving the slide which causes the release of the second juvenile-seat rotation latch 224 by pulling on the actuator cable 220 (not shown in FIG. 33 but see FIG. 29).

A first juvenile-seat rotation latch 24′ is shown in FIG. 34 which is configured as a “bump off”. The first juvenile-seat rotation latch 24′ can lightly hold the seat in an orientation but does not provide substantial locking of the seat against significant rotation forces. This is instead provided by the second juvenile-seat rotation latch 224. The “bump off” first juvenile-seat rotation latch 24′ is intended to stop the seat orientation controller 18′ and the seat 14′ from rotating freely once the second juvenile-seat rotation latch 224 has been released and the seat orientation controller 18′ unlocked. The rotation of the seat 14′ is then a deliberate and controlled act made by the person operating the restraint. If no “bump off” was provided, then the seat orientation controller 18′ and seat 14′ may rotate freely as soon as the second juvenile-seat rotation latch 224 has been released and the seat orientation controller 18′ unlocked in an undesirable and uncontrolled manner.

In the second embodiment, the first juvenile-seat rotation latch 24′ is configured so that the rotational retention force of the first juvenile-seat rotation latch 24′ can be easily overcome by rotating the seat orientation controller 18′ once the second juvenile-seat rotation latch 224 has been released. For example, the biasing force of the biasing element, in the form of a spring 290, which moves the first juvenile-seat rotation latch 24′ upwardly to the locked position may be selected so that rotation of the seat orientation controller 18′ causes the seat motion blocker 64′ to impart a lateral force of on the ramped internal surfaces 241a, 242a of the ramps 241′, 242′ of first juvenile-seat rotation latch 24′ which overcomes the biasing of spring 290. The lateral force on the ramped internal surfaces 241a, 242a causes the first juvenile-seat rotation latch 24′ to pivot downwardly about pivot point 292 and thus releases the seat motion blocker 64′ from between the ramps 241′, 242′ so that the seat orientation controller 18′ can freely rotate. The resistance provided by the first juvenile-seat rotation latch 24′ is easily overcome by rotation of the seat orientation controller 18′ whereas the resistance provided by the second juvenile-seat rotation latch 224 is not.

During testing, the applicant has found that the first juvenile-seat rotation latch 24 of the first embodiment alone was not sufficient to prevent rotation of the seat orientation controller 18′ and seat 14′ under particular test conditions, for example those required to meet Australian standard 1754. According to the applicant's testing, the provision of a second juvenile-seat rotation latch 224 as described herein can augment or replace the first juvenile-seat rotation latch 24′ and prevent rotation of the seat orientation controller 18′ and seat 14′ such that the requirements of the standard may be achieved. Mounting the second juvenile-seat rotation latch 224 in the upper portion 28′ of the base to the support assembly 206 improves the resistance to rotation of the seat orientation controller 18′ and seat 14′ compared to the first juvenile-seat rotation latch 24′ alone, which is only mounted to the shell 27 of the base. The second juvenile-seat rotation latch 224 is able to withstand larger forces as it can transfer the loads to the support assembly 206.

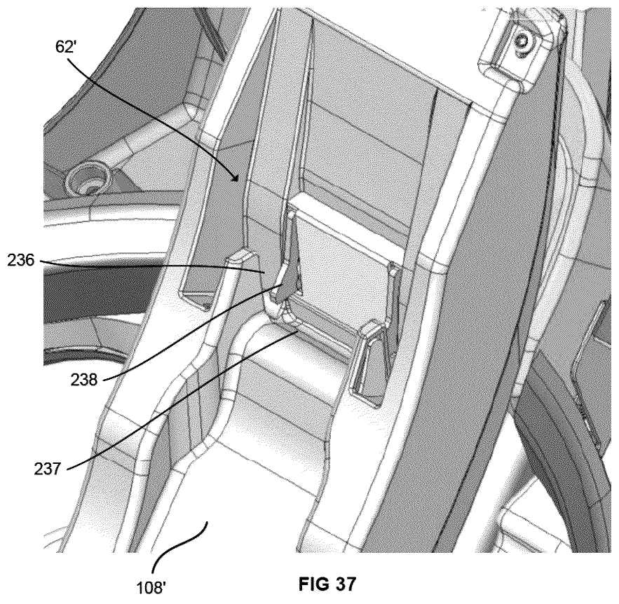

Attention is now turned to the second retainer unit 62′ (FIG. 37) which removably attaches the seat 14′ to the seat orientation controller 18'. FIGS. 35 and 36 show the seat 14′ having an upper backrest portion 204 and a bottom portion 202. An elongate recess 232 extends along the exterior of the seat 14′ at the midline. The recess 232 is an elongate depression in the outer surface of the seat 14′ and configured to accommodate the seat orientation controller 18′ such that the seat 14′ sits within the concave foundation basin 30′ in which the seat orientation controller 18′ is also mounted, as discussed in relation to the first embodiment (see FIG. 4). Disposed in the recess 232 at the backrest portion 204 is a bar 234 which is receivable in the rear end retainer 62′ on the orientation controller 18′, shown in FIG. 37. The bar 234 is attached to the structure of the seat 14′. This rear end retainer 62′ is a latch which, in combination with the front end seat retainer 60′, removably holds the seat 14′ on the orientation controller 18′.

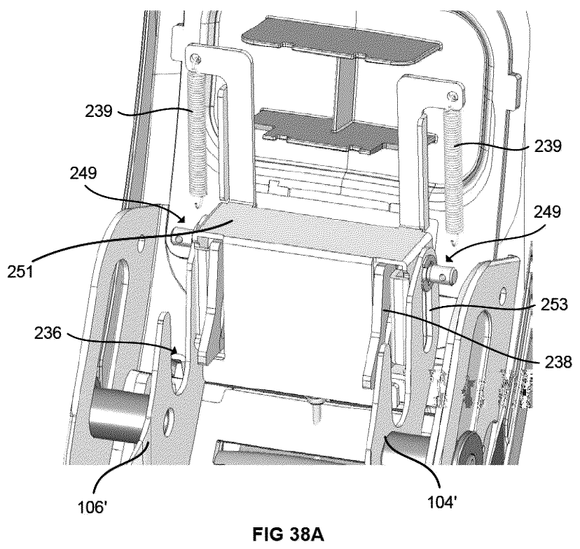

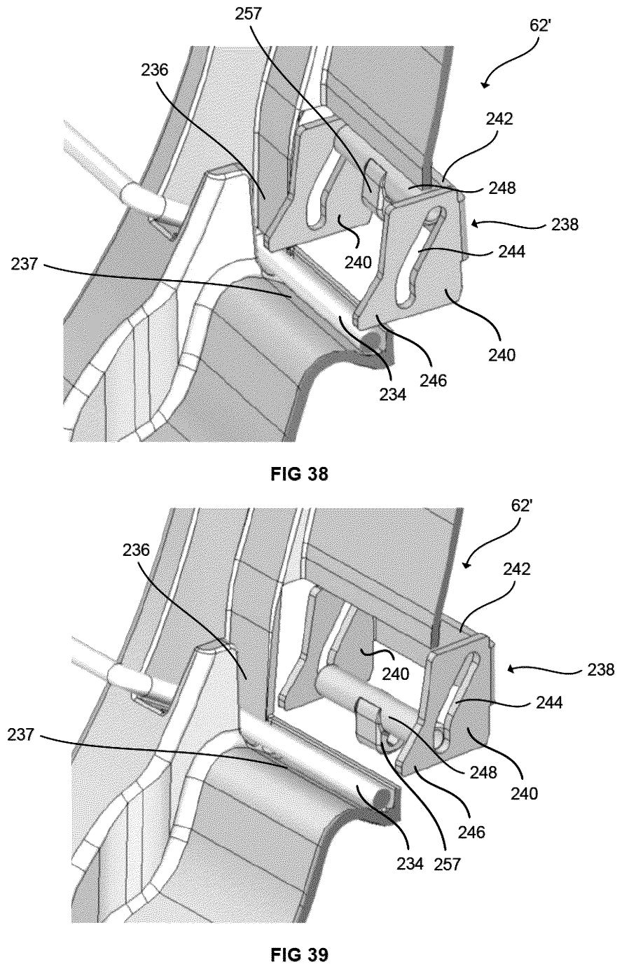

As shown in FIG. 37, the rear end retainer 62′ includes spaced deep grooves 236 (only one of which is shown in FIG. 38), for receiving the bar 234 of the backrest portion of the seat. Extending between spaced deep grooves 236 is a shallow groove 237 for seating the bar 234. A latch element 238 is arranged to project into the space between the deep grooves 236 to capture and retain the bar 234 until the latch element is released. The latch element 238 projects over the bar 234 when seated in the shallow groove as shown in FIG. 38.

The rear end retainer 62′ is shown in FIG. 38A which is a perspective view of the seat orientation controller 18′ with the top cover 108′ removed. The rear end retainer 62′ includes first and second springs 239 which each attach to either end of an operator 248 (see FIGS. 38 and 39). It will be appreciated that in the figures the springs are not yet connected to the operator 248 due to a shortcoming of the CAD figures.

The operator 248 is a bar that extends across the width of the rear end retainer 62′. The operator 248 moves in aligned guide slots 253 in the carrier beams 104′, 106′ and in both legs of a bracket 251 (guide slots in the bracket 251 are not visible). The bracket 251 might be incorporated into the carrier beams 104′, 106′. However, components of the first embodiment have been modified to produce the second embodiment.

End portions 249 of the operator 248 extend through the aligned guide slots guides 253 in the carrier beams 104′, 106′ and the legs of the bracket 251. The guides in the bracket 251 and the carrier beams 104′, 106′ are aligned and of a similar size and shape. The guides in the bracket 251 and the carrier beams 104′, 106′ restrict the movement of the operator 248 to generally linear motion, depending on the angle of the movable recline carriage 74 and hence the angle of the slot 253.

The rear end retainer 62′ is further shown in FIG. 38 which is a detailed cross section of the bar 234 retained by the latch element 238 in the shallow groove 237. The latch element 238 includes spaced apart latch plates 240 which are joined by a cross plate 242. The latch plates 240 include a main portion with a slot 244 and a wedge shaped finger portion 246 extending away from the main portion.

The springs 239 bias the operator 248 upwards. Given that the movement of the operator 248 is constrained to up/down movement, with the operator to 48 biased into an upward position, the end portions 249 of the operator 248 push the locking element 238 into the locked position via the engagement between the end portions 249 and the slots 244, as in FIG. 38A and FIG. 38. The rear end retainer 62′ is then in a normally closed or latched position unless retracted, as discussed below.

As discussed above, the end portions 249 of the operator element 248 engaged within the slots 244 can slide up and down within the slots 244. The slots 244 have an upright section located toward the finger portion 246 and an angled section which extends upward and away from the upright section and toward the cross plate 238. The operator 248 may only move up and down due to the restriction imposed by the guides 253 and therefore the arrangement of the slot 244 causes latch element 238 to move away from the grooves 236, 237 when the operator 248 is pulled down. When the operator 248 is not pulled down, the biasing force of the springs 239 acting on the operator 248 will pull the operator upwards which then pushes the locking element 238 forward to the latched position shown in FIG. 38.

In FIG. 38, the latch element 238 is in the latched or forward position in which the wedge shaped finger portions 246 project between the deep grooves 236 and above the bar 234. The horizontal lower edge of the finger portion 246 prevents the bar 234 from being drawn out of the recess 236. The ramped upper edge of the finger portion 246 allows the latch element 238 to be pushed toward an unlatched position (shown in FIG. 39) when the bar 234 is being lowered into the groove 236, 237 and bears against the ramped upper edge, for example when the seat 14′ is being placed on the seat orientation controller 18′.

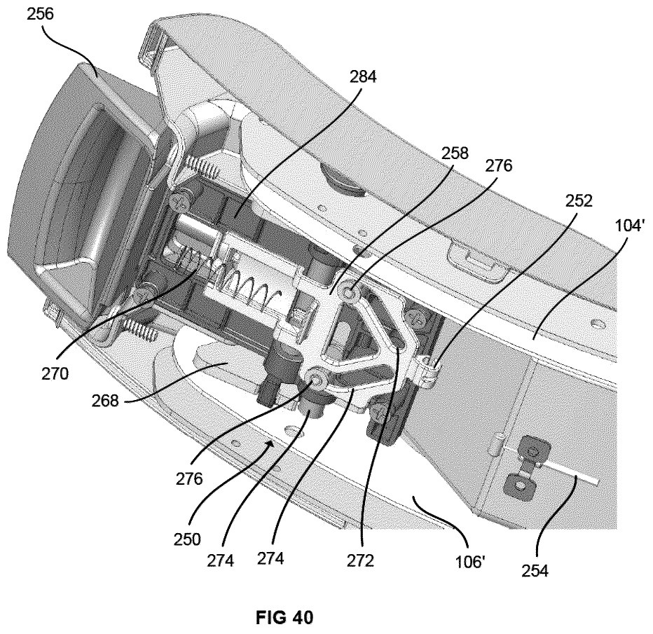

FIG. 39 shows the latch element 238 in a retracted or unlatched position. The operator element 248 has been pulled downwards which has caused the latch element to retract away from the groove 236, 237 due to the engagement between the end portions 249 and the slot 244. The operator 248 is pulled down by the operation of an unlocking mechanism 250 shown in FIG. 40. The unlocking mechanism 250 includes a cable (not shown) which extends from an end 252 of a handle assembly through guide means 254 to the operator 248. The cable hooks onto a connection point 257 (see FIG. 38) in the middle of the operator 248.

As shown in FIG. 40, the handle assembly includes pull handle 256 and an actuator plate 258. The actuator plate 258 includes a connection point 252 for the cable at one end and is operably connected to the front end retainer 60′ (see FIG. 41). The unlocking mechanism 250 can then be actuated by pulling on the pull handle 256 to unlatch both the front end retainer 60′ and the rear end retainer 62′ simultaneously.

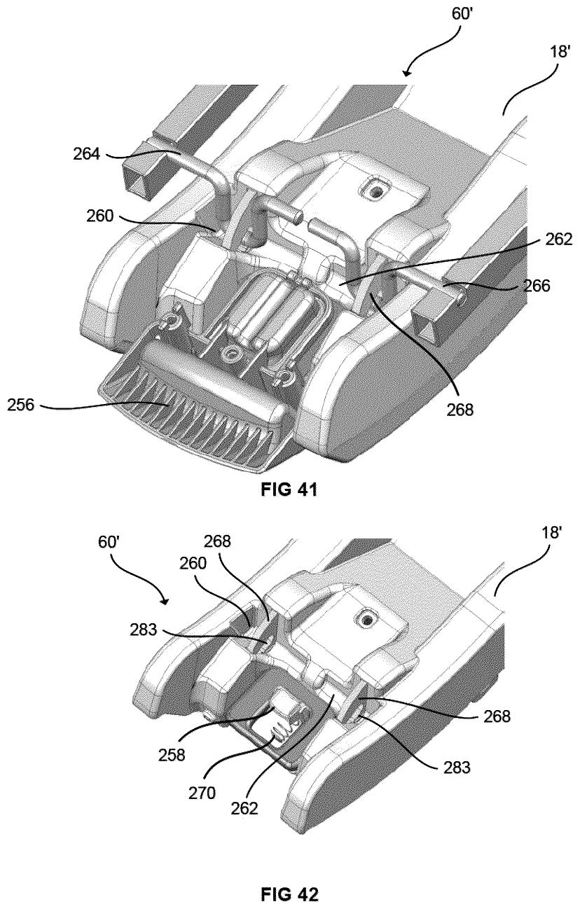

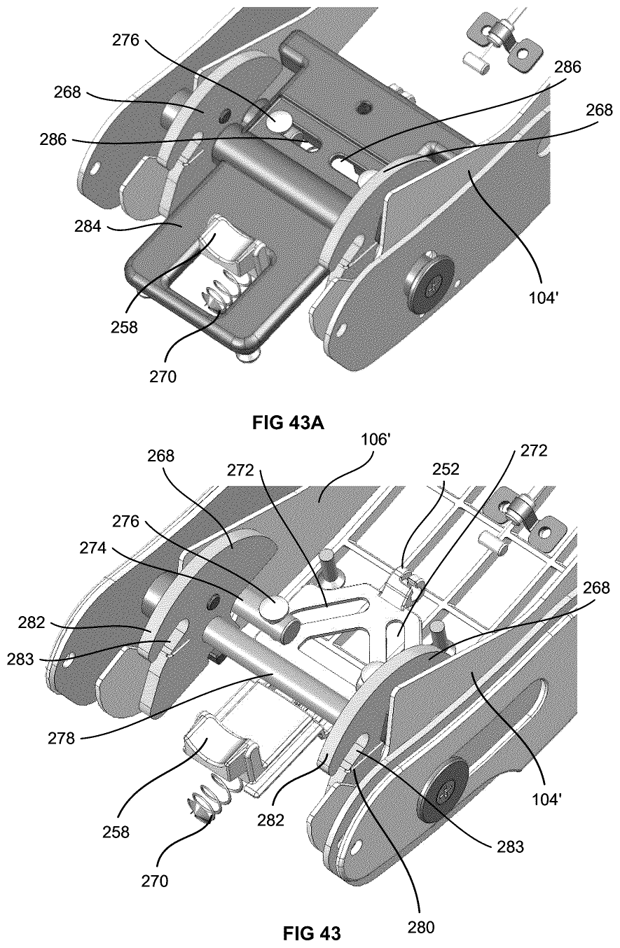

The front end retainer 60′ is similar to the first embodiment and is described in further detail with reference to FIGS. 41 and 42. The front end retainer 60′ includes left and right grooves 260, 262 in the seat orientation controller 18′ for receiving respective bars 264, 266 mounted on the bottom portion 202 of the seat 14′ (although a single bar could be provided). Latch elements 268 are disposed such that their hooked ends 282 (see FIG. 43) project into the grooves 260, 262 to capture and retain the bars 264, 266 when in the latched position and until the pull handle 256/actuator plate 258 is operated. The latch elements 268 are shown in the latched position in FIGS. 40 to 44. The bars 264, 266 are retained in a detent 283 formed by the hook shaped end of the latch elements 258. The front end retainer latch element 268 is operated simultaneously with the rear end latch element 238 when the handle 256 is actuated.

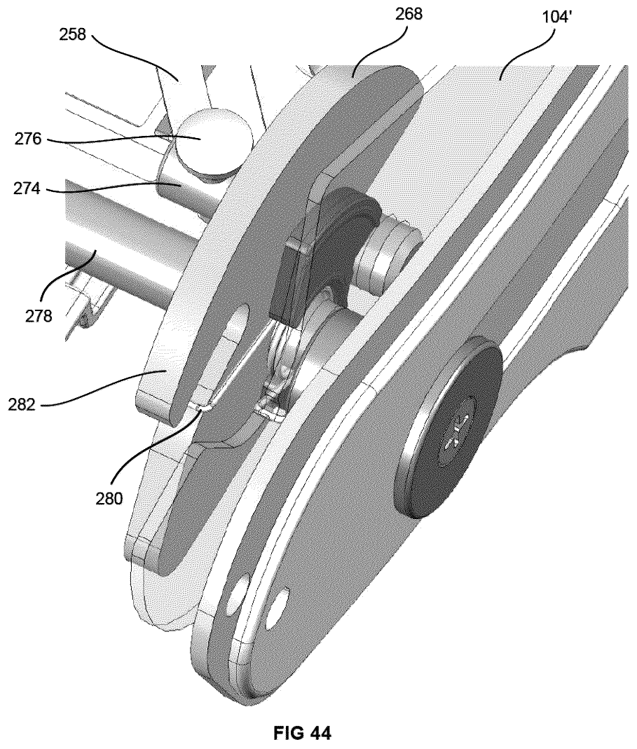

The actuator plate 258 is biased by a spring 270 into a rearward latched position as shown in FIG. 40, FIG. 43A and FIG. 43. The actuator plate 258 is slidable forwardly against the bias of the spring 270 when the handle 256 is pulled. FIG. 43A shows the top plate 284 of the unlocking mechanism 250. The top plate 284 is fixed to the seat orientation controller 18′. FIG. 43 shows the unlocking mechanism with the top plate 284 removed for clarity. The top plate 284 includes left and right lateral slots 286. The actuator plate 258 shown in FIG. 43 includes left and right angled slots 272. The left and right lateral slots 286 and the left and right angled slots 272 engage with respective left and right locking pins 274 which are guided in the slots by respective bosses 276. The locking pins 274 are restricted to lateral movement by the bosses 276 running in lateral slots 286. The left and right slots 272 angle inwardly toward the rear end 252 of the actuator plate 258. The locking pins 274 slidably project into holes (shown in FIG. 44) in the recline beams 104′, 106′ when the actuator plate 258 is in the latched position, as shown in FIG. 40, FIG. 43 and FIG. 44. As the actuator plate 258 is pulled forward when the handle 256 is pulled forward, the bosses 276 are pulled laterally inward away from the recline beams 104′, 106′ by the angled slots 272 through which the bosses 276 pass. This causes the locking pins 274 to retract from the holes.

The latch elements 268 are pivotally mounted on a pivot bar 278 which is in turn supported at either end by the recline beams 104′, 106′. The latch elements 268 are biased toward the latched position by latching axial springs 280 (see also FIG. 44) which extend from the recline beams 104′, 106′ to the respective latch elements 268. When the actuator plate 258 is in the latched position (see FIG. 40 and FIG. 43) the locking pins 274 are disposed underneath the locking elements 268 and thereby prevent the latch elements 268 from rotating toward the unlocked position. In this arrangement, the latch elements 268 are maintained in the latched position and the bars 264, 266 are retained within the detents 283.

As discussed above, when the actuator plate 258 is pulled forward the engagement of the bosses 276 in the left and right lateral slots 286, left and right angled slots 272 causes the locking pins 274 to be pulled inwardly and away from the openings in the recline beams 104′, 106′. This removes the impediment to the rotation of the latch elements 268. The latch elements 268 are then free rotate to an unlatched position (note shown) as the bars 264, 266 are lifted away from the grooves 260, 262 when the seat 14′ is lifted away from the seat orientation controller 18′. The lifting of the bars 264, 266 pushes against the detent to cause the latch elements 268 to rotate. The latch elements 268 are biased back to the latched position by the latching axial springs 280 once the bars 264, 266 are removed from the detents 283. The spring 270 returns the actuator plate 258 to the rearward position which also returns the locking pins 274 to the locked position and in engagement with the holes in the recline beams 104′, 106′.

The combination of a front end retainer 60′ and a rear end retainer 62′ provides a secure and reliable mounting of the seat 14′ to the seat orientation controller 18′ and base 12′. The applicant has found that under certain test or crash conditions, the forces involved could decouple a seat mounted using only a front end retainer from the orientation controller. Providing a second, rear end retainer to reduce the risk of this decoupling improves safety of the vehicular seat. Further, a mechanism for actuating both the front and the rear end retainers simultaneously provides a simple and user friendly arrangement.

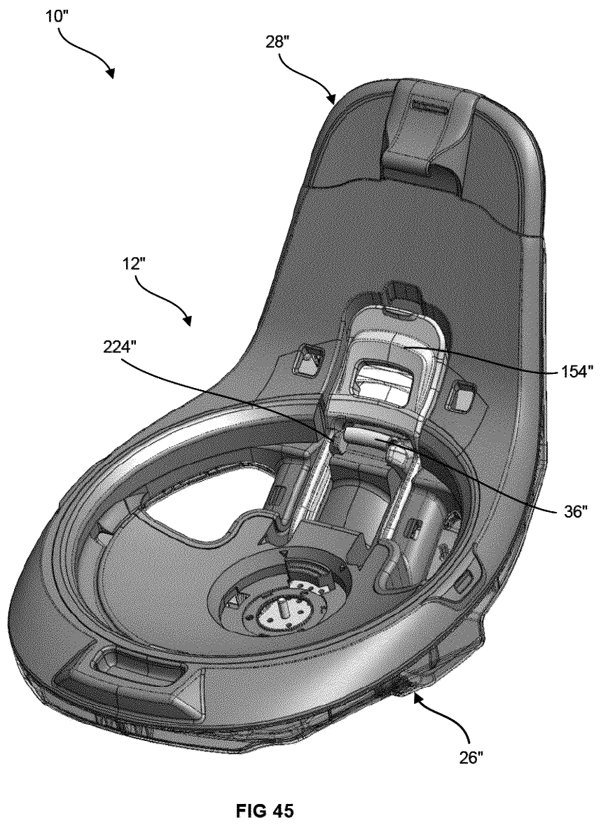

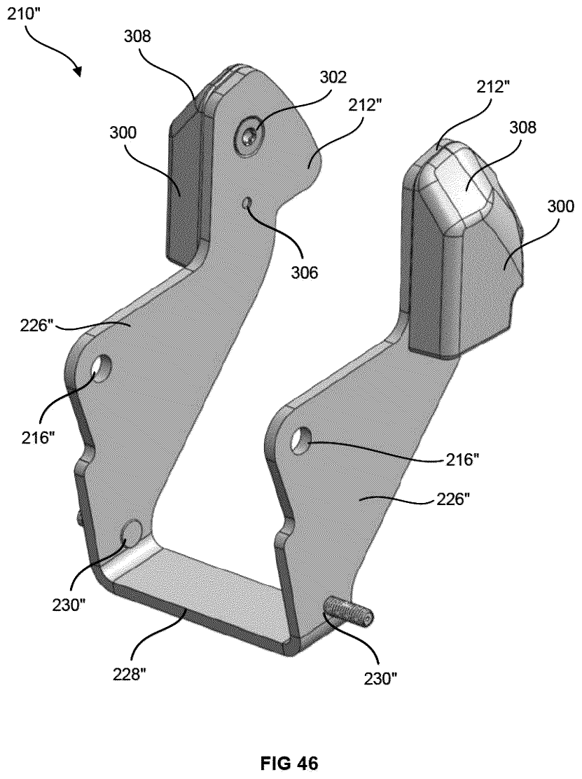

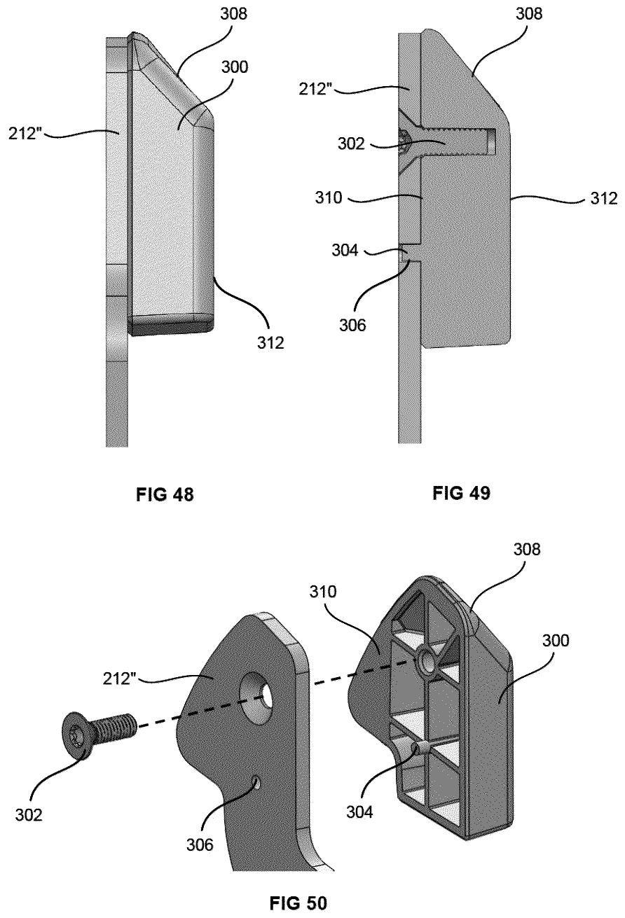

FIGS. 45 to 53 depict a third embodiment of a child restraint 10″. The restraint 10″ of the third embodiment is substantially the same as the restraint 10′ of the second embodiment. Accordingly, the description above regarding the restraint 10′ of the second embodiment (and by extension the restraint 10 of the first embodiment, where applicable) equally applies to the restraint 10″ of the third embodiment. Accordingly, like reference numerals are used where parts of the restraint 10″ of the third embodiment are the same or similar as the respective parts of the restraint 10′ of the second embodiment, with the addition of the double prime (″) to indicate the third embodiment. The difference between the restraints of the second and third embodiments resides in the arrangement of the locking element 210″ (see FIG. 46) of the second juvenile-seat rotation latch 224″, as discussed further below.

Referring to FIG. 45, the base 12″ of the restraint 10″ of the third embodiment is shown. The seat-orientation controller 18', and the juvenile seat 14′ are not shown in FIG. 45 for clarity but would otherwise be provided on the restraint 10″ as discussed above regarding the restraint 10′ of the second embodiment. The base 12″ includes an upper portion 28″ and a lower portion 26″. A second juvenile-seat rotation latch 224″ and a seat belt retainer 154″ are provided on the base 12″.

The second juvenile-seat rotation latch 224″ and the seat belt retainer 154″ of the third embodiment differ to those provided on the restraint 10′ of the second embodiment. As depicted in FIGS. 46 to 50, the locking element 210″ of the second juvenile-seat rotation latch 224″ includes ramps 300. The ramps 300 face outwardly from the locking element 210″ and are arranged so that the seat motion blocker 66′ (as shown in FIGS. 28 to 31) will contact the angled face 308 of the ramps 300 when the seat 14′ mounted to the orientation controller 18′ is being rotated into the forward facing or rearward facing arrangements. The angled face 308 of the ramp 300 will translate the rotation of the seat 14′ into backwards movement of the locking element 210″ and cause the locking element 210″ to retract or pivot from the locked position to the unlocked position (see FIGS. 28 and 29), without the need to actuate the locking element 210″ using the actuator 222 (FIG. 33) which operates the locking element 210″ via the actuating cable 220. The seat motion blocker 66′ (shown in FIGS. 28 and 29), the actuator 222 and the actuating cable 220 are discussed above regarding the restraint 10′ of the second embodiment and are unchanged in the restraint 10″ of the third embodiment.

By further rotating the seat 14′, the seat motion blocker 66′ can then be moved between the locking portions 212″ (FIG. 46) and the locking element 210″ will be biased back into the locked position to retain the seat motion blocker 66′ between the locking portions 212″. Thus, when the seat is freely rotating between the forward and rearward facing positions, a carer may manipulate the seat 14′ into the desired arrangement simply by rotating the seat 14′ such that it clicks into place.

As best shown in FIGS. 49 and 50, the ramps 300 are preferably each a separate component which is secured to the locking portions 212″ using screws 302. The screw 302 is preferably countersunk so that the head is flush with the inside of the locking portion 212″. The ramps 300 also include a locating pin 304 which locates into hole or recess 306 in the locking portion 212″. The pin 304 aids in locating the ramp 300 on the locking portions 212″ and aids in preventing rotation or misalignment of the ramp 300 during use.

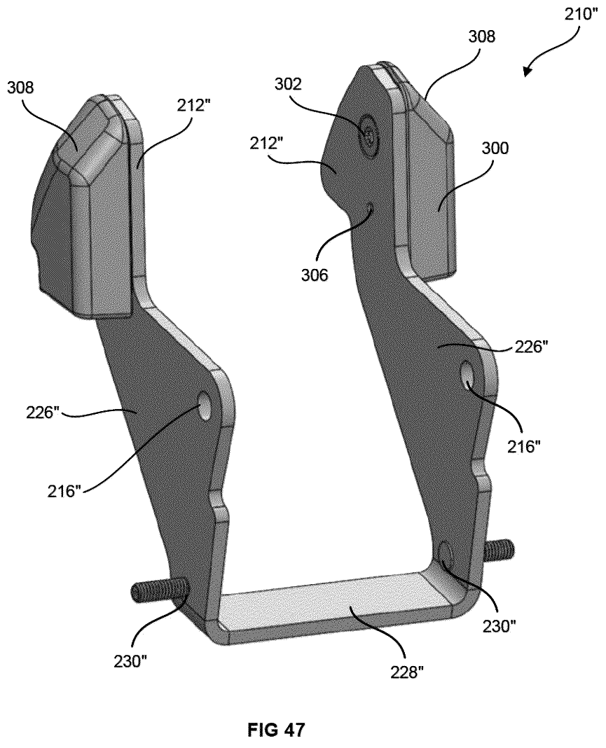

The ramps 300 each include an inner face 310 which contacts the locking portion 212″ and an outer face 312 which faces away from the locking portion 212″. The angled face 308 extends between the outer face 312 and the inner face 312. The angled face 308 is preferably provided at about a 45 degree angle to the inner face 310 and the outer face 312, sloping downwardly away from the inner face 310 (given the orientation shown in FIG. 47), and thus is also at an angle of about 45 degrees to the locking portion 212″. The ramp 300 may be made of any suitably durable material but is preferably made of a hard plastic, for example polyamide 6 with 30% glass fibre reinforcement (PA6 GF30). Other suitable materials include nylon, ABS, polyethylene, or polypropylene.

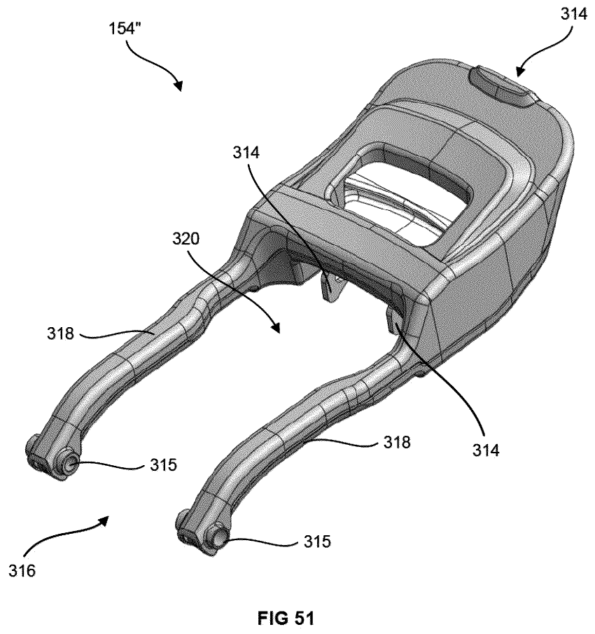

FIG. 51 shows the seat belt retainer 154″ which is arranged to accommodate the additional width of the locking element 210″ which has the ramps 300 mounted to it. The seat belt retainer 154″ includes a handle end 314 for a user to lift the seat belt retainer 154″ about the pivots 315 on the pivot end 316. Between the handle end 314 and the pivot end 316 are two arm portions 318 which define a space 320 therebetween. The arms 318 are arranged to allow the locking portions 212″ and ramps 300 to extend between the arms 318 in space 320 as shown in FIG. 45.

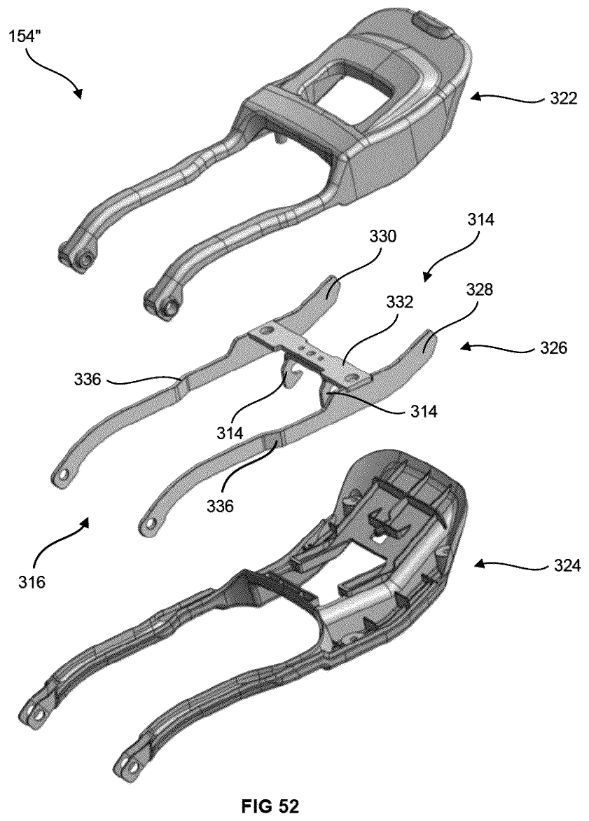

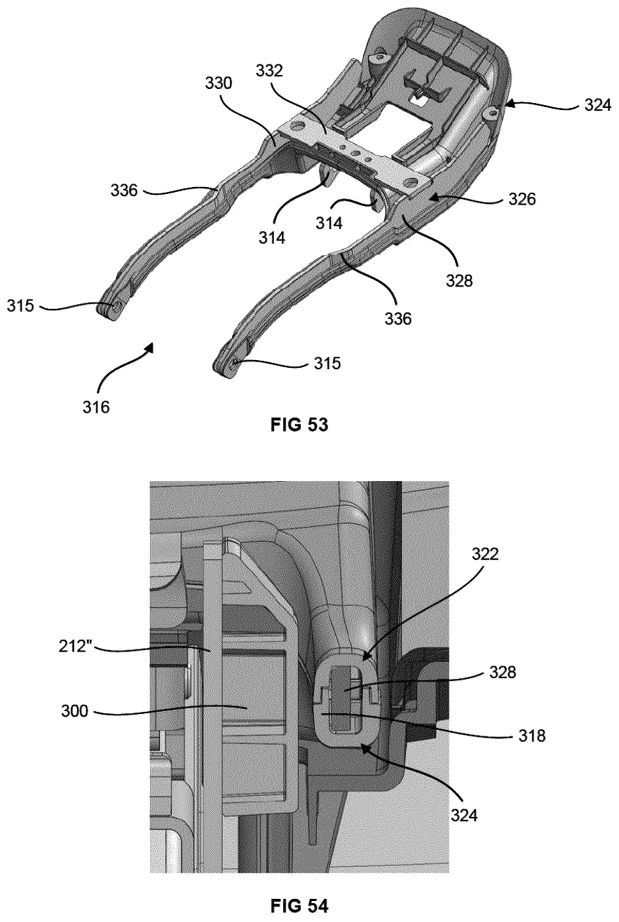

As shown in FIG. 52, the seat belt retainer 154″ includes a top cover 322, a bottom cover 324 and a middle portion 326 sandwiched between the top cover 322 and bottom cover 324. FIG. 53 illustrates how the middle portion 326 fits within the bottom cover 324. The top and bottom cover are preferably plastic and have rounded edges so that they do not damage a belt which is passed below the seat belt retainer 154″. The middle portion 326 is preferably made of plates or strips of metal, for example steel plate, to provide strength to the seat belt retainer 154″. The middle portion 326 is a generally “H” shaped component having a first plate 328 and a second plate 330 which are parallel and spaced from one another. The first and second plates 328, 320 are joined intermediate their ends by a generally perpendicular cross plate 332 which is preferably welded to the first and second plates 328, 330. Hook portions 334 depend from the cross plate 332 and extend through the bottom cover 324 to secure the seat belt retainer 154″ to the base 12″ in a locked position, as depicted in FIG. 45. The first and second plates 328, 320 shown in FIG. 52 include a dogleg 336 which flares the first and second plates 328, 330 outwardly such that the handle end 314 of the plates 328, 330 is farther apart than the pivot end 316 of the plates 328, 330. This provides the space to accommodate the locking portions 212″ and ramps 300 passing between the arms 318 of the seat belt retainer 154″ when in the locked position.

FIG. 54 is a cross section through the seat belt retainer 154″ and the locking portion 212″ with one of the ramps 300. A gap of about 2 mm is provided between the arms 318 and the ramp 300.

The seat belt retainer 154 and 154′ discussed regarding the restraints 10, 10′ of the first and second embodiments may also have a similar construction. However, as the locking portions 212′ are thinner in the second embodiment, or not present in the first embodiment, the thickness of the arm portions 318 and the width of the space 320 is of less importance for the first and second embodiments. Accordingly, the middle portion 326 may be constructed in a different manner which forms thicker arm portions. For example, square, rectangle or round metal bar or tube may be used rather than thinner plates.

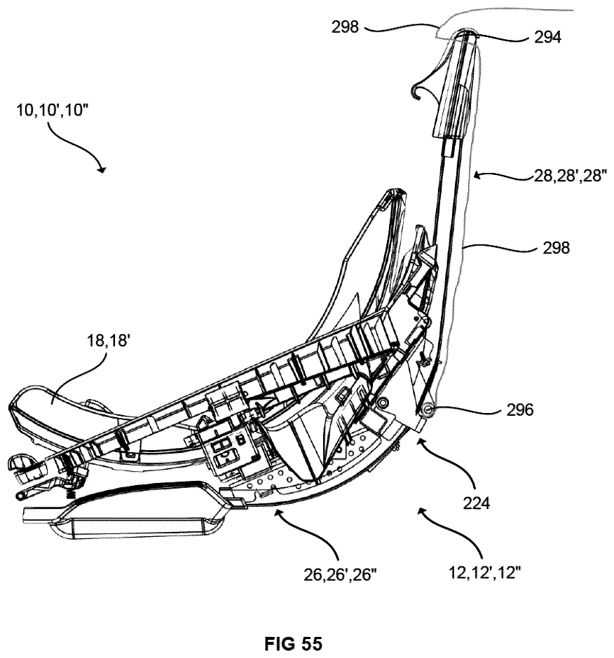

The restraints 10, 10′, 10″ of the first embodiment, the second embodiment, and the third embodiment have a top tether strap 298 which extends from the base 12, 12′, 12″ of the restraint to a vehicle anchor point (not shown). The path of the top tether 298 is shown in FIG. 55. The restraint 10, 10′, 10′″ in FIG. 55 is shown with the outer surface of the base 12, 12′, 12″ removed so that the path of the top tether strap 298 is visible. The seat 14, 14′, 14″ is also removed in FIG. 55.

The top tether 298 is secured to the base 12, 12′, 12″ at a top tether connection point 296 (also shown in FIG. 26 and FIG. 27). The connection point 296 is located in the base portion 12, 12′, 12″ and near the second juvenile-seat retainer latch 224, if provided. The top tether 298 extends from the connection point 296 inside the base 12, 12′, 12″ and upwardly inside the upper portion 28, 28′, 28″ toward an aperture 294 (also shown in FIG. 25). The aperture 294 is located toward the top of the upper portion 28, 28′, 28″ and is formed such that is open toward the seat portion 14, 14′, 14″ (not shown in FIG. 54). That is, the aperture 294 is facing away from the vehicle seat backrest (not shown). The top tether 298 passes through the aperture 294 and then extends from the aperture 294 toward the vehicle anchor point to which it secured.

Locating the connection point 296 low down in the base 12, 12′, 12″ increases the overall length of the top tether 298 when it is connected to the anchor point. This is beneficial as it increases the potential extension of the top tether strap 298 in the event of a crash. This can lower the overall tension experienced by the top tether strap 298 in the event of a crash and thus reduce the likelihood of the top tether strap 298 and/or the connection to the vehicle anchor point failing.

It will be understood that the present disclosure disclosed and defined in this specification extends to all alternative combinations of two or more of the individual features mentioned or evident from the text or drawings. All of these different combinations constitute various alternative aspects of the present disclosure.

Infants and children travelling in a vehicle, such as a car, are often required by law to be seated in an appropriate vehicular child restraint. Ingress and egress of the child to the restraint is a task which complicated by the necessity that the restraint be installed in either a forward or rearward facing orientation when in use. To simplify this task, the seat is rotatable relative to a base secured to the vehicle seat. The seat may be rotated such that it faces the vehicle door to provide improved access to the seat for the child and a caregiver.

Restraints may also have seats which are removable from the base. The removable seat can then be used as part of a larger restraint system, for example the seat could be mounted to a stroller or pram when not installed on the restraint base. An infant may remain in the seat and the seat itself transferred from the vehicle restraint to a pram. This removes or reduces the need to remove the infant from the restraint and transfer the infant to another piece of equipment and vice versa.

Under Australian law, child restraints should be designed and tested according to AS 1754. The testing required by the standard imparts significant forces to the child restraint which simulate various real world crash scenarios. Creating a child restraint that has a seat which is rotatable relative to the base and/or a seat which is removable from the base is a significant challenge in view of the requirements of AS 1754. For example, under the Australian testing conditions, a test dummy should be used that is 22 kg, which is approximately equivalent to a four to five year old child. This test dummy is larger and heavier than the test dummies used in other jurisdictions. There is also a requirement that the seat pass tests involving impacts from the front, rear, sides, and a simulated vehicle roll over to an inverted position. These tests should all be passed when the restraint is arranged in both the forward and rearward facing orientations, as applicable.

Many restraints that are built for countries other than Australia will not pass the Australian design and testing requirements, further exacerbating the task as all restraints should be configured specifically for Australian conditions. For example, the restraint described in United States patent application 18/383702 (publication number 2024/0140278) was found by the applicant to fail the Australian crash testing requirements.

It is therefore desirable to provide a vehicular child restraint that includes the benefits of a rotatable and/or removable seat which may satisfy Australian testing requirements.

### Rotation Locking Arrangement

A first aspect of the present disclosure provides a child restraint comprising:
a base including a lower portion configured to rest on a seat portion of a vehicle seat and an upper portion extending away from the lower portion configured to rest on a back portion of the vehicle seat;
a mounting assembly rotatably attached to the base and configured to mount a seat for accommodating a child to the base in at least a forward-facing arrangement or a rearward facing arrangement; and
a rotation locking mechanism, the rotation locking mechanism including:
   at least one motion blocking portion provided on one of the mounting assembly and an upper portion of the base; and
   two spaced locking portions disposed on the other of the mounting assembly and the upper portion of the base, the two spaced locking portions configured such that the at least one motion blocking portion is disposed between the two spaced locking portions when the seat is secured in the forward-facing arrangement or the rearward facing arrangement thereby restricting rotation of the mounting assembly relative to the base,
   wherein the rotation locking mechanism is operable to selectively displace the locking portions thereby removing the restriction on rotation of the mounting assembly relative to the base.

Preferably, the two spaced locking portions are disposed on the upper portion of the base and the at least one motion blocking portion is provided on the mounting assembly.

The rotation of the mounting assembly is restricted or restrained by the capturing of the motion blocking portion between the locking portions. A small amount of movement or play of the motion blocking portion between the locking portions might be permissible however. When the locking portions are displaced by operation of an actuator, the mounting assembly may rotate about a seat rotation axis that projects upwardly from a central part of the bottom portion of the base.

The mounting assembly may be configured to mount the seat to the base in at least a forward-facing arrangement and a rearward facing arrangement. The at least one motion blocking portion may be associated with the forward facing arrangement of the seat or the rearward facing arrangement of the seat. The mounting assembly may have a first motion blocking portion associated with the forward facing arrangement of the seat. The mounting assembly may have a second motion blocking portion associated with the rearward facing arrangement of the seat. The motion blocking portion or portions may each include a projection which protrudes away from the mounting assembly, preferably generally toward the base, when the mounting assembly is mounted to the base. The projection or projections may include a plate, such as a curved plate. The plate may project substantially orthogonally to an exterior surface of the mounting assembly. The plate may include a flat portion and a curved portion. The curved portion may form a hook shape on the free end of the flat portion of the plate. The plate may have a generally J-shaped profile.

Alternatively, or in addition, the motion blocking portion or portions may be disposed in a recess which extends into the mounting assembly. The recess may be a slot, a groove, a channel, a pocket.

The mounting assembly may be configured to releasably mount the seat to the base such that the seat is selectively removable. The mounting assembly may include a seat locking arrangement as described below in relation to the second aspect.

The base may define an inner space in which the mounting assembly and the seat may be disposed. The base may define a concave portion. The concave portion may be disposed on the lower portion of the base. The mounting assembly may be at least partially disposed in the concave portion. The mounting assembly may be of complementary shape to the concave portion of the base.

As described above, the seat rotation axis may extend generally upwardly away from the lower portion. In some embodiments, the seat rotation axis may be substantially orthogonal to the lower portion, preferably substantially orthogonal to a plane which lies on a rim of the concave portion.

The locking mechanism may include an actuator. Preferably, the actuator is operable to selectively displace the locking portions thereby removing the restriction on rotation of the mounting assembly relative to the base. The actuator may be provided on the base. The actuator may be disposed away from the two spaced locking portions. The actuator may be disposed on the lower portion of the base. The actuator may be disposed on the lower portion of the base in a location remote from where the upper portion extends from the lower portion. The actuator may be disposed on the lower portion of the base in a location opposite from where the upper portion extends from the lower portion.

The actuator may be operably connected to the locking portions. Selective movement of the actuator may displace the locking portions. The actuator may be operably connected to the locking portions using a connecting element. The connecting element may include a linkage. The connecting element may include a linkage including a rod, a bar, a cable, or a combination thereof. The actuator may include a slide, a lever, a button, or a handle. In a preferred embodiment, the actuator includes a slide connected to a cable which extends to the locking portions such that the locking portions are selectively displaceable on movement of the slide.

The base may include a support assembly. The support assembly may be configured to provide structural support to the base. The support assembly may extend from the lower portion of the base to the upper portion of the base. The support assembly may be disposed toward the midline of the child restraint when viewed from the forward facing or rearward facing direction. The support assembly may include a beam. The beam may be configured to be accommodated within the lower portion and the upper portion of the base. The beam may include a first portion disposed in the lower portion and a second portion disposed in the upper portion. The first portion of the beam may be disposed in a generally or substantially horizontal position when the restraint is in use. The second portion of the beam may be disposed in a generally upward or substantially upright position when the restraint is in use. The beam may include a third portion intermediate the first and second portions. The third portion may be curved from the generally or substantially horizontal position to the generally upward or substantially upright position.

The support assembly may include a first beam and a second beam. The first and second beams may be arranged as described in the previous paragraph. The first and second beams may be disposed next to one another. The first and second beams may be substantially parallel. The first and second beams may be disposed on either side of the midline of the restraint.

Preferably, the locking portions are provided on a single locking element. The locking element may be mounted to the support assembly. The locking element may be mounted to the second portion of the support assembly. The locking element may be pivotably mounted to the support assembly. The locking element may be biased by a biasing element. The locking element may be biased by a biasing element into a first position. The locking element may be selective displaceable to a second position on operation of the actuator. When in the first position, the locking portions of the locking element may protrude into the inner space of the base. When in the second position, the locking portions of the locking element may be displaced away from the inner space of the base. The locking portions may be located inside the base, preferably the upper portion of the base, when in the second position.

The locking element may include first and second spaced apart locking arms. The locking portions may be provided on the locking arms. The locking portions may be provided on respective distal ends of the locking arms. The locking arms may be joined by an intermediate portion. The intermediate portion may extend between the first and second locking arms. The intermediate portion may connect to a proximal end of the first and second arms which is opposite to the locking portions. The locking element may have a generally U-shaped profile or generally C-shape profile.

A pivot may be provided on the locking arms. A biasing element may connect to the locking arms or the intermediate portion. The connecting element associated with the actuator may connect to the locking element, preferably at one or both the locking arms or the intermediate portion. The biasing element and the connecting element may connect to the same positions on the locking element. The biasing element and the connecting element may connect to different positions on the locking element.

The locking arms may be generally planar. Each locking arm may include a body portion and a nose portion. The nose portion may extend away from the body portion. The locking portions may be provided on the nose portions. The body portion may include the pivot. The biasing element and/or the connecting element may connect to one or both bodies of the locking arms.

Each of the locking portions may include a ramp portion. The ramp portions may be configured to allow the motion blocking portion to move the locking portions from the first position to the second position. The ramp portions may be configured to allow the motion blocking portion to move the locking portions from the first position to the second position when the motion blocking portion is rotating into either the forward or rearward facing position. The ramp portion may be provided on the locking arms. The ramp portion on one locking portion may protrude generally away from the other locking portion. The ramp portions may be on the outside of the locking arms.

Preferably, the ramp portions may each be a separate ramp component mounted to the locking portions, preferably the locking arms. The ramp portions may include a ramp surface. The ramp portions may include a ramp body. The ramp surface may be at an angle to a first side of the ramp body (e.g. the first ramp body side). The first ramp body side may be substantially parallel to the locking arm. The ramp body may include a second ramp body side which, when mounted to the locking portion, is substantially parallel to the locking arms. The first and second ramp body sides may be substantially parallel to each other. The ramp portion may be mounted to the locking portion such that the second ramp body side is substantially flush with the locking arm. The first ramp body side may face away from the locking arm. The second ramp body side may be larger in a length dimension than the first ramp body side. The ramp surface may extend between the first and second ramp body side such that the ramp surface is not orthogonal to the first and second ramp body side. The ramp surface may extend between a first end of the first ramp body side and a first end of the second ramp body side. The ramp surface may be at an angle to the locking arm. The angle of the ramp surface to the locking arm may be in the range of about 10 degrees to about 80 degrees, preferably about 30 degrees to about 60 degrees, or more preferably about 45 degrees.

Each of the ramp portions may be mounted to the locking portions using a mechanical fastener such as a bolt, a screw or a rivet. Preferably, each the ramp portions may be mounted to the respective locking portions using a screw fastener. A threaded hole may be provided on the ramp portion and configured to receive the screw fastener. The threaded hole may be provided on the ramp body. The threaded hole may be provided on the second ramp body side. The ramp portion may include a pin. The pin may be configured to engage with a locating hole in the locking portion, preferably on the locking arm. The pin may be provided on the second ramp body side. The engagement between the pin and the locating hole may locate the ramp portion on the locking portion. The engagement between the pin and the locating hole may resist movement or rotation of the ramp portion with respect to the locking portion.

In an alternative embodiment, the ramp portions may each be integrally formed with respective locking portions. In this embodiment, the locking arms may not be generally planar. The locking portions may include a contour portion. The ramp portions may be at least partially defined by a contour portion. The contour portions may be formed by angling or bending a portion of the locking portions or the locking arms to form the contours. Alternatively, the ramp portions may be formed by a thicker portion of the locking portion. The ramp portion may project from the respective locking portion in a direction generally away from the other locking portion. The ramp portion may include a ramp surface. The ramp surface may be at an angle to the locking arm. The angle of the ramp surface to the locking arm may be in the range of about 10 degrees to about 80 degrees, preferably about 30 degrees to about 60 degrees, or more preferably about 45 degrees.

The intermediate portion may be generally planar. The intermediate portion may be at least as long as the motion blocking portion of the mounting assembly. Accordingly, the distance or space between the locking arms may be at least as wide as the motion blocking portion of the mounting assembly.

The locking element may be connected to the beam or beams. The locking element may be connected to the beam or beams via at least one pivot shaft which mounts to the pivot of the locking element. The at least one pivot shaft may be mounted to the beam or beams using a bracket. The locking element may be arranged on the beam or beams such that the locking arms extend either side of the beam or beams. The intermediate portion may extend across the beam or beams. The intermediate portion may extend across the beam or beams on a side which his toward an exterior of the base.

In an alternative embodiment, the locking portions may be provided on separate locking elements, preferably a first locking element and a second locking element. Each locking element may include a locking arm. The locking elements may be substantially the same as described above but are not connected by the intermediate portion. The distance or space between the first and second locking elements may be at least as wide as the motion blocking portion of the mounting assembly.

The locking elements may be connected to the beam or beams. The locking elements may be connected to the beam or beams via at least one pivot shaft which mounts to the pivots of the locking elements. The at least one pivot shaft may be mounted to the beam or beams using a bracket. The locking element may be arranged on the beam or beams such that the locking arms extend either side of the beam or beams.

In either embodiment, the bracket which mounts the locking element to the beam or beams may include a first bracket arm and a second bracket arm. The bracket arms may be spaced from one another. The bracket arms may be spaced from one another by a web portion. The web portion may extend between the first and second bracket arms. The bracket arms may extend away from the inner space of the base. The web portion may extend across the beam or beams. The web portion may extend across the beam or beams on a side which is toward the inner space of the base. The bracket arms may be spaced apart by an amount which allows the bracket arms to be disposed between the locking arms. The bracket arms may include the at least one pivot shaft. The bracket arms may each include a pivot shaft configured to interact with the pivot on the locking arms. A single pivot shaft may extend between the first and second bracket arms. The bracket may be arranged on the beam or beams such that the pivot shaft extends across the beam or beams on a side which his toward the inner space of the base. The bracket may include a reinforcing element. The reinforcing element may extend between the bracket arms. The reinforcing element may extend between the bracket arms across the beam or beams. The reinforcing element may extend between the bracket arms across the beam or beams on a side which side which is toward an exterior of the base.

The mounting assembly may be rotatably connected to the base via a bearing assembly. The mounting assembly may be rotatably connected to the base at the support assembly. The mounting assembly may be connected to the beam or beams. The mounting assembly may be connected to the first portion of the support assembly. The mounting assembly may be connected to the first portion of the support assembly via a coupling. The bearing assembly may be mounted to the coupling.

The restraint may further include a second rotation locking mechanism arranged on the base. The second rotation locking mechanism may include a second actuation mechanism disposed on the base. Alternatively, the second actuation mechanism may be operable using the first actuator. The second rotation locking mechanism may include two space locking portions which are similar to those described above.

In a preferred embodiment, the second rotation locking mechanism differs from the first rotation locking mechanism. The second rotation locking mechanism may include locking portions that are combined with a fulcrum. The locking portions may be provided on one end of the fulcrum. The locking portions may be biased toward a locked position by a biasing element. The fulcrum may be pivotally mounted to the base at an end opposite the locking portions. The fulcrum may be a third-class lever. The locking portions may be moved out of the locked position by at least one motion blocking portion imparting a lateral force on one of the locking portions. The second rotation locking mechanism may provide a resistance to rotation that is less than a resistance to rotation provided by the first rotation locking mechanism.

The child restraint may further include a seat configured to accommodate a child or an infant. The seat may be selectively removable from the child restraint. The child restraint may further include a seat latching arrangement and associated features as described below in relation to the second aspect. Any of the features described below in relation to the second aspect of the present disclosure may have application to the first aspect of the present disclosure.

### Seat Attaching Arrangement

A second aspect of the present disclosure provides a child restraint comprising:
a base configured to rest on a vehicle seat;
a seat including a bottom portion and a backrest portion defining an interior for accommodating a child, the seat further including a first attachment portion disposed on an exterior of the backrest portion and a second attachment portion disposed on an exterior of the bottom portion;
a mounting assembly disposed on the base including a first mount and a second mount;
wherein the first attachment portion and the first mount are configured to lockingly engage, and the second attachment portion and the second mount are configured to lockingly engage; and
wherein the seat is removable by selectively disengaging the first attachment portion and the second attachment portion from their respective first and second mounts.

The first attachment portion and the first mount may form a first latch. The second attachment portion and the second mount may form a second latch. Each latch may include a bar and a catch.

The exterior surface of the seat may include a recess. The recess may extend from the bottom portion to the backrest portion. The recess may take the form of a groove or channel. The recess may be configured such that the mounting assembly is receivable within the recess when the seat is mounted to the mounting assembly. The first attachment portion may be disposed within the recess. The second attachment portion may be disposed within the recess.

The mounting assembly may be configured to be of complementary shape to the recess in the seat. The mounting assembly may be a curved or arc shape. The mounting assembly may have a generally U-shape or C-shape. The mounting element may be generally elongate in shape.

The mounting assembly may have a first end and a second end. The first mount may be disposed toward the first end. The second mount may be disposed toward the second end. Preferably, the mounts are provided on an upward facing side of the mounting assembly so that they may engage the attachment portions.

In an embodiment, one of the first attachment portion and the first mount includes a first bar and the other of the first attachment portion and the first mount includes a first catch to receive the first bar. The locking engagement may operate to restrict the first bar from dislocating from the first catch. Preferably, the first attachment portion is the first bar and the first mount is the first catch.

The first bar may be disposed within the recess at the backrest portion of the seat. The first bar may extend substantially across the recess. The first catch may include a groove for receiving the first bar. The first catch preferably further includes a latch element to retain the first bar in the groove.

The latch element may be positionable to a latched position in which the bar is retained in the groove and an unlatched position in which the bar is removable from the groove. The latch element is disengaged when in the unlatched position. The latch element may include a latch plate. The latch plate may include a main portion and a finger portion which projects away from the main portion. The finger portion may have a wedge shape. The finger portion may have a lower edge that is colinear with a lower edge of the main portion. An upper edge of the finger portion may be at an acute angle to the lower edge.

The latch element may be biased toward the latched position, preferably by a latch biasing element. In the latched position the bar may be retained in the groove by the lower edge of the finger portion. When the bar is inserted into the groove, the angled upper edge provides a means for the bar to displace the latch plate and fall into the groove. Once the bar clears the finger portion and is fully seated in the groove, the latch plate is returned to the latched position by the patch biasing element.

The latch plate may include a slot. The slot may be formed in the main portion. The slot may include an inclined portion. The slot may have a generally vertical portion disposed toward the finger portion and an angled portion the extends upwardly and away from the finger portion. An operator element may engage with the slot. When in the latched position, the operator element is located toward the top of the slot. When in the unlatched position, the operator element is displaced toward the bottom of the slot. The operator element may be operably connected to an unlocking mechanism, described further below. The operator element may be operable by the unlocking mechanism to move within the slot and cause movement of the latch plate from the latched to the unlatched positions.

The latch element may include first and second latch plates, the latch plates may be as described above in the immediately preceding paragraphs. The latch plates may be spaced apart from one another. The latch plates may be connected by the operator element only. The first and second latch plates are then separate plates which are joined by the operator element to form the latch element. In a preferred embodiment, the latch plates are additionally joined by a cross plate. The cross plate may be located on an edge of the latch plates that is opposite the finger portions.

In an embodiment, one of the second attachment portion and the second mount includes a second bar and the other of the second attachment portion and the second mount includes a second catch to receive the second bar. The locking engagement my operate to restrict the second bar dislocating from the second catch. Preferably, the second attachment portion is a bar and the second mount is a catch.

The second attachment portion may include a third bar. The second catch may include first and second catch portions. The first and second catch portions may be arranged to catch the second and third bars of the second attachment portion. The first and second catch portions of the second latch may each be a plate. The second catch portion may include a recess configured to receive the second and third bar. The second catch portion may include a first recess configured to receive the second bar. The second catch portion may include a second recess configured to receive the third bar. The first and second catch portions may be selectively movable on operation of an unlocking mechanism, discussed further below. The first and second catch portions may be selectively movable from a latched position in which the second and third bars are retained in the recess (or first and second respective recesses) by the first and second latch portions, to an unlatched position in which the second and third bars are removable from the recess or recesses.

The first and second latches may be selectively moveable to an unlocked position so that the attachment portions may be removable from the respective first and second mounts. The latches may be independently selectively moveable. The latches may be simultaneously selectively moveable. The mounting assembly may include an unlocking mechanism for selectively moving the first and second latches to the unlocked position simultaneously. The mounting assembly may include unlocking mechanisms associated with the first and second latches for selectively moving the first and second latches to the unlocked position independently of one another.

The unlocking mechanism may be located toward one end of the mounting assembly. The unlocking mechanism may be located toward the second end of the mounting assembly. The unlocking mechanism may be located near to the second mount, for example near to the second latch.

The unlocking mechanism may include an unlocking plate. The unlocking plate may be coupled to the second latch. The unlocking plate may be coupled to the first latch. The unlocking plate may be coupled to the first latch via a connecting member. The connecting member may include a linkage. The linkage may include a rod, a bar, or a cable. The unlocking plate may be configured to be movable with respect to the mounting assembly to thereby operate the unlocking mechanism. The unlocking plate may be slidable or rotatable relative to the mounting assembly. The unlocking plate may include a lever, a handle, or a button to facilitate movement. In a preferred embodiment, the unlocking mechanism is slidable relative to the mounting assembly. When moved, the unlocking plate engages with the second latch to unlatch the second latch. The unlocking plate also simultaneously causes actuation of the first latch via a cable that extends from the unlocking plate to the operator element.

The mounting assembly may be rotatably attached to the base. The mounting assembly and/or the base may be arranged as described above in relation to the first aspect.

Any of the features described above in relation to the first aspect of the present disclosure may have application to the second aspect of the present disclosure.

It will also be understood that the present disclosure(s) disclosed and defined in this specification extends to all alternative combinations of two or more of the individual features mentioned or evident from the text or drawings. All of these different combinations constitute various alternative aspects of the present disclosure.

A child restraint comprises a base, a mounting assembly rotatably attached to the base and a rotation locking mechanism. The base includes a lower portion configured to rest on a seat portion of a vehicle seat and an upper portion extending away from the lower portion and configured to rest on a back portion of the vehicle seat. The mounting assembly which is rotatably attached to the base, is configured to mount a seat for accommodating a child to the base in at least a forward-facing arrangement or a rearward facing arrangement. The rotation locking mechanism includes at least one motion blocking portion provided on one of the mounting assembly and an upper portion of the base. Two spaced locking portions are disposed on the other of the mounting assembly and the upper portion of the base. The two spaced locking portions are configured such that the at least one motion blocking portion is disposed between the two spaced locking portions when the seat is secured in the forward-facing arrangement or the rearward facing arrangement, thereby restricting rotation of the mounting assembly relative to the base. The rotation locking mechanism is operable to selectively displace the locking portions thereby removing a restriction on rotation of the mounting assembly relative to the base.

The following numbered clauses include embodiments that are contemplated and non-limiting:

Clause 1. A child restraint comprising:
a base including a lower portion configured to rest on a seat portion of a vehicle seat and an upper portion extending away from the lower portion and configured to rest on a back portion of the vehicle seat;
a mounting assembly rotatably attached to the base and configured to mount a seat for accommodating a child, to the base in at least a forward-facing arrangement or a rearward facing arrangement; and
a rotation locking mechanism, the rotation locking mechanism including:
   at least one motion blocking portion provided on one of the mounting assembly and an upper portion of the base; and
   two spaced locking portions disposed on the other of the mounting assembly and the upper portion of the base, the two spaced locking portions configured such that the at least one motion blocking portion is disposed between the two spaced locking portions when the seat is secured in the forward-facing arrangement or the rearward facing arrangement thereby restricting rotation of the mounting assembly relative to the base,
   wherein the rotation locking mechanism is operable to selectively displace the locking portions thereby removing the restriction on rotation of the mounting assembly relative to the base.

Clause 2. The child restraint of clause 1, wherein the two spaced locking portions are disposed on the upper portion of the base and the at least one motion blocking portion is provided on the mounting assembly.

Clause 3. The child restraint of clause 1, the at least one motion blocking portion is associated with the forward facing arrangement of the seat and/or the rearward facing arrangement of the seat.

Clause 4. The child restraint of clause 1, wherein the mounting assembly has a first motion blocking portion and a second motion blocking portion.

Clause 5. The child restraint of clause 1, further including a seat, wherein the mounting assembly is rotatable to a forward facing position and a rearward facing position and thereby configured to mount the seat to the base in at least a forward-facing arrangement and a rearward facing arrangement.

Clause 6. The child restraint of clause 1, wherein the at least one motion blocking portion includes a projection which protrudes away from the mounting assembly generally toward the base.

Clause 7. The child restraint of clause 6, wherein the at least one projection includes a curved plate.

Clause 8. The child restraint of clause 1, wherein the rotation locking mechanism includes an actuator operable to selectively displace the locking portions thereby removing the restriction on rotation of the mounting assembly relative to the base.

Clause 9. The child restraint of clause 1, wherein the locking portions are provided on a single locking element.

Clause 10. The child restraint of clause 9, wherein the locking element includes first and second spaced apart locking arms with the locking portions provided on respective locking arms.

Clause 11. The child restraint of clause 10, wherein the locking arms are joined by an intermediate portion wherein the intermediate portion is at least as long as the at least one motion blocking portion of the mounting assembly.

Clause 12. The child restraint of clause 10, wherein the locking element is pivotably mounted to a support assembly which forms a portion of the base, the support assembly being configured to provide structural support for the base.

Clause 13. The child restraint of clause 10, wherein the locking element is biased by a biasing element into a first position and selectively displaceable to a second position, on operation of an actuator, whereby in the first position, the locking portions of the locking element overlap with the at least one motion blocking portion and in the second position, are displaced relative to the at least one motion blocking portion.

Clause 14. The child restraint of clause 13, wherein the base defines an inner space in which the mounting assembly is disposed and in the first position, the locking portions of the locking element protrude into the inner space of the base, and in the second position, the locking portions of the locking element are displaced away from the inner space of the base.

Clause 15. The child restraint of clause 13, wherein the at least one motion blocking portion is rotatable with the mounting assembly, and

wherein each of the locking portions includes a ramp portion whereby the ramp portions are configured to allow the at least one motion blocking portion to move the locking portions from the first position to the second position during rotation of the at least one motion blocking portion.

Clause 16. The child restraint of clause 15, wherein the ramp portions each comprise a separate ramp component mounted to the locking portions.

Clause 17. The child restraint of clause 1, wherein the at least one motion blocking portion is rotatable with the mounting assembly, and

wherein at least one of the locking portions includes a ramp portion configured to allow the motion blocking portion to displace the locking portion(s) during rotation of the at least one motion blocking portion.

Clause 18. The child restraint of clause 1 further including a second rotation locking mechanism arranged on the base.

Clause 19. A child restraint comprising:
a base configured to rest on a vehicle seat;
a seat including a bottom portion and a backrest portion defining an interior for accommodating a child, the seat further including a first attachment portion disposed on an exterior of the backrest portion and a second attachment portion disposed on an exterior of the bottom portion;
a mounting assembly disposed on the base including a first mount and a second mount;
wherein the first attachment portion and the first mount are configured to lockingly engage, and the second attachment portion and the second mount are configured to lockingly engage; and
wherein the seat is removable by selectively disengaging the first attachment portion and the second attachment portion from their respective first and second mounts.

Clause 20. The child restraint of clause 19, wherein the exterior surface of the seat includes a recess which extends from the bottom portion to the backrest portion and configured such that the mounting assembly is receivable within the recess when the seat is mounted to the mounting assembly.

Clause 21. The child restraint of clause 20, wherein the first attachment portion is disposed within the recess.

Clause 22. The child restraint of clause 21, wherein the second attachment portion is disposed within the recess.

Clause 23. The child restraint of clause 19, wherein the mounting assembly is configured to be of complementary shape to the recess in the seat.

Clause 24. The child restraint of clause 23, wherein the mounting assembly has a first end and a second end and the first mount is disposed toward the first end and the second mount is disposed toward the second end.

Clause 25. The child restraint of clause 19, wherein one of the first attachment portion and the first mount includes a first bar and the other of the first attachment portion and the first mount includes a first catch to receive the first bar and wherein the locking engagement is operable to restrict the first bar from dislocating from the first catch.

Clause 26. The child restraint of clause 25, wherein one of the second attachment portion and the second mount includes a second bar and the other of the second attachment portion and the second mount includes a second catch to receive the second bar and wherein the locking engagement is operable to restrict the second bar from dislocating from the second catch.

Clause 27. The child restraint of clause 19, wherein the mounting assembly includes an unlocking mechanism for selectively moving the first and second latches to the unlocked position simultaneously.

Clause 28. The child restraint of clause 19, wherein the mounting assembly includes unlocking mechanisms associated with the first and second latches respectively for selectively moving the first and second latches to the unlocked position independently of one another.

1. A child restraint comprising:
a base including a lower portion configured to rest on a seat portion of a vehicle seat and an upper portion extending away from the lower portion and configured to rest on a back portion of the vehicle seat;
a mounting assembly rotatably attached to the base and configured to mount a seat for accommodating a child, to the base in at least a forward-facing arrangement or a rearward facing arrangement; and
a rotation locking mechanism, the rotation locking mechanism including:
at least one motion blocking portion provided on one of the mounting assembly and an upper portion of the base; and
two spaced locking portions disposed on the other of the mounting assembly and the upper portion of the base, the two spaced locking portions configured such that the at least one motion blocking portion is disposed between the two spaced locking portions when the seat is secured in the forward-facing arrangement or the rearward facing arrangement thereby restricting rotation of the mounting assembly relative to the base,
wherein the rotation locking mechanism is operable to selectively displace the locking portions thereby removing the restriction on rotation of the mounting assembly relative to the base.

2. The child restraint as claimed in claim 1, wherein the two spaced locking portions are disposed on the upper portion of the base and the at least one motion blocking portion is provided on the mounting assembly.

3. The child restraint as claimed in claim 1, the at least one motion blocking portion is associated with the forward facing arrangement of the seat and/or the rearward facing arrangement of the seat.

4. The child restraint as claimed in claim 1, wherein the mounting assembly has a first motion blocking portion and a second motion blocking portion.

5. The child restraint as claimed in claim 1, further including a seat, wherein the mounting assembly is rotatable to a forward facing position and a rearward facing position and thereby configured to mount the seat to the base in at least a forward-facing arrangement and a rearward facing arrangement.

6. The child restraint as claimed in claim 1, wherein the at least one motion blocking portion includes a projection which protrudes away from the mounting assembly generally toward the base.

7. The child restraint as claimed in claim 6, wherein the at least one projection includes a curved plate.

8. The child restraint as claimed in claim 1, wherein the rotation locking mechanism includes an actuator operable to selectively displace the locking portions thereby removing the restriction on rotation of the mounting assembly relative to the base.

9. The child restraint as claimed in claim 1, wherein the locking portions are provided on a single locking element.

10. The child restraint as claimed in claim 9, wherein the locking element includes first and second spaced apart locking arms with the locking portions provided on respective locking arms.

11. The child restraint as claimed in claim 10, wherein the locking arms are joined by an intermediate portion wherein the intermediate portion is at least as long as the at least one motion blocking portion of the mounting assembly.

12. The child restraint as claimed in claim 10, wherein the locking element is pivotably mounted to a support assembly which forms a portion of the base, the support assembly being configured to provide structural support for the base.

13. The child restraint as claimed in claim 10, wherein the locking element is biased by a biasing element into a first position and selectively displaceable to a second position, on operation of an actuator, whereby in the first position, the locking portions of the locking element overlap with the at least one motion blocking portion and in the second position, are displaced relative to the at least one motion blocking portion.

14. The child restraint as claimed in claim 13, wherein the base defines an inner space in which the mounting assembly is disposed and in the first position, the locking portions of the locking element protrude into the inner space of the base, and in the second position, the locking portions of the locking element are displaced away from the inner space of the base.

15. The child restraint as claimed in claim 13, wherein the at least one motion blocking portion is rotatable with the mounting assembly, and
wherein each of the locking portions includes a ramp portion whereby the ramp portions are configured to allow the at least one motion blocking portion to move the locking portions from the first position to the second position during rotation of the at least one motion blocking portion.

16. The child restraint as claimed in claim 15, wherein the ramp portions each comprise a separate ramp component mounted to the locking portions.

17. The child restraint as claimed in claim 1, wherein the at least one motion blocking portion is rotatable with the mounting assembly, and
wherein at least one of the locking portions includes a ramp portion configured to allow the motion blocking portion to displace the locking portion(s) during rotation of the at least one motion blocking portion.

18. The child restraint as claimed in claim 1 further including a second rotation locking mechanism arranged on the base.

19. A child restraint comprising:
a base configured to rest on a vehicle seat;
a seat including a bottom portion and a backrest portion defining an interior for accommodating a child, the seat further including a first attachment portion disposed on an exterior of the backrest portion and a second attachment portion disposed on an exterior of the bottom portion;
a mounting assembly disposed on the base including a first mount and a second mount;
wherein the first attachment portion and the first mount are configured to lockingly engage, and the second attachment portion and the second mount are configured to lockingly engage; and
wherein the seat is removable by selectively disengaging the first attachment portion and the second attachment portion from their respective first and second mounts.

20. The child restraint as claimed in claim 19, wherein the exterior surface of the seat includes a recess which extends from the bottom portion to the backrest portion and configured such that the mounting assembly is receivable within the recess when the seat is mounted to the mounting assembly, wherein the first attachment portion is disposed within the recess, and wherein the second attachment portion is disposed within the recess.
